(19) United States
(12) Patent Application Publication
(10) Pub. No.: US 2024/0323716 A1
(43) Pub. Date: Sep. 26, 2024

(54) DATA COLLECTION ENHANCEMENTS FOR SIDELINK

(71) Applicant: QUALCOMM Incorporated, San Diego, CA (US)

(72) Inventors: Shankar Krishnan, San Diego, CA (US); Karthika Paladugu, Hyderabad (IN)

(21) Appl. No.: 18/187,331

(22) Filed: Mar. 21, 2023

(51) Int. Cl. H04W 24/04; H04W 76/14

(52) U.S. Cl. CPC H04W 24/04; H04W 76/14

(57) ABSTRACT

This disclosure provides systems, methods, and devices for wireless communication that support enhanced sidelink reporting operations. In a first aspect, a device for wireless communication includes at least one processor and a memory coupled to the at least one processor. The at least one processor is configured to detect a radio link failure for a link with a second network node, and to generate sidelink radio link failure information based on the detected radio link failure. The at least one processor is further configured to transmit the sidelink radio link failure information to a third network node, the sidelink radio link failure information including location information, radio link failure cause information, or both. Other aspects and features are also claimed and described.

### TECHNICAL FIELD

Aspects of the present disclosure relate generally to wireless communication systems, and more particularly, to enhanced sidelink information reporting. Some features may enable and provide improved communications, including reduce failures and improved operations when operating in sidelink and/or when out of coverage of a network device from the enhanced sidelink information reporting.

### INTRODUCTION

Wireless communication networks are widely deployed to provide various communication services such as voice, video, packet data, messaging, broadcast, and the like. These wireless networks may be multiple-access networks capable of supporting multiple users by sharing the available network resources. Such networks may be multiple access networks that support communications for multiple users by sharing the available network resources.

A wireless communication network may include several components. These components may include wireless communication devices, such as base stations (or node Bs) that may support communication for a number of user equipments (UEs). A UE may communicate with a base station via downlink and uplink. The downlink (or forward link) refers to the communication link from the base station to the UE, and the uplink (or reverse link) refers to the communication link from the UE to the base station.

A base station may transmit data and control information on a downlink to a UE or may receive data and control information on an uplink from the UE. On the downlink, a transmission from the base station may encounter interference due to transmissions from neighbor base stations or from other wireless radio frequency (RF) transmitters. On the uplink, a transmission from the UE may encounter interference from uplink transmissions of other UEs communicating with the neighbor base stations or from other wireless RF transmitters. This interference may degrade performance on both the downlink and uplink.

As the demand for mobile broadband access continues to increase, the possibilities of interference and congested networks grows with more UEs accessing the long-range wireless communication networks and more short-range wireless systems being deployed in communities. Research and development continue to advance wireless technologies not only to meet the growing demand for mobile broadband access, but to advance and enhance the user experience with mobile communications.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

In one aspect of the disclosure, a method of wireless communication includes detecting a radio link failure for a link with a second network node, and generating sidelink radio link failure information based on the detected radio link failure. The method further includes transmitting the sidelink radio link failure information to a third network node, the sidelink radio link failure information including location information, radio link failure cause information, or both.

In an additional aspect of the disclosure, an apparatus configured for wireless communication is disclosed. The apparatus includes at least one processor, and a memory coupled to the at least one processor. The at least one processor is configured to detect a radio link failure for a link with a second network node, and to generate sidelink radio link failure information based on the detected radio link failure. The at least one processor is further configured to transmit the sidelink radio link failure information to a third network node, the sidelink radio link failure information including location information, radio link failure cause information, or both.

In an additional aspect of the disclosure, an apparatus configured for wireless communication is disclosed. The apparatus includes means for detecting a radio link failure for a link with a second network node, and means generating sidelink radio link failure information based on the detected radio link failure. The apparatus further includes means for transmitting the sidelink radio link failure information to a third network node, the sidelink radio link failure information including location information, radio link failure cause information, or both.

In an additional aspect of the disclosure, a non-transitory computer-readable medium stores instructions that, when executed by a processor, cause the processor to perform operations including detecting a radio link failure for a link with a second network node, and generating sidelink radio link failure information based on the detected radio link failure. The operations further include transmitting the sidelink radio link failure information to a third network node, the sidelink radio link failure information including location information, radio link failure cause information, or both.

In an additional aspect of the disclosure, a method of wireless communication includes receiving, from a first user equipment (UE), sidelink radio link failure information associated with a radio link failure for the first UE and a second UE, the sidelink radio link failure information including location information, radio link failure cause information, or both.

In an additional aspect of the disclosure, an apparatus configured for wireless communication is disclosed. The apparatus includes at least one processor, and a memory coupled to the at least one processor. The at least one processor is configured to receive, from a first user equipment (UE), sidelink radio link failure information associated with a radio link failure for the first UE and a second UE, the sidelink radio link failure information including location information, radio link failure cause information, or both.

In an additional aspect of the disclosure, an apparatus configured for wireless communication is disclosed. The apparatus includes means for receiving, from a first user equipment (UE), sidelink radio link failure information associated with a radio link failure for the first UE and a second UE, the sidelink radio link failure information including location information, radio link failure cause information, or both.

In an additional aspect of the disclosure, a non-transitory computer-readable medium stores instructions that, when executed by a processor, cause the processor to perform operations including receiving, from a first user equipment (UE), sidelink radio link failure information associated with a radio link failure for the first UE and a second UE, the sidelink radio link failure information including location information, radio link failure cause information, or both.

Other aspects, features, and implementations will become apparent to those of ordinary skill in the art, upon reviewing the following description of specific, exemplary aspects in conjunction with the accompanying figures. While features may be discussed relative to certain aspects and figures below, various aspects may include one or more of the advantageous features discussed herein. In other words, while one or more aspects may be discussed as having certain advantageous features, one or more of such features may also be used in accordance with the various aspects. In similar fashion, while exemplary aspects may be discussed below as device, system, or method aspects, the exemplary aspects may be implemented in various devices, systems, and methods.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 is a block diagram illustrating example details of an example wireless communication system according to one or more aspects.

FIG. 2 is a block diagram illustrating examples of a base station and a user equipment (UE) according to one or more aspects.

FIG. 3 is a diagram of an example of connection establishment operations for a remote UE connecting to a network through a relay UE.

FIG. 4 is a block diagram illustrating an example wireless communication system that supports enhanced sidelink information reporting according to one or more aspects.

FIG. 5 is a timing diagram illustrating an example process that supports enhanced sidelink information reporting according to one or more aspects.

FIG. 6 is a timing diagram illustrating an example process that supports enhanced sidelink information reporting according to one or more aspects.

FIG. 7 is a timing diagram illustrating an example process that supports enhanced sidelink information reporting according to one or more aspects.

FIG. 8 is a timing diagram illustrating an example process that supports channel sidelink information reporting according to one or more aspects.

FIG. 9 is a timing diagram illustrating an example process that supports enhanced sidelink information reporting according to one or more aspects.

FIG. 10 is a timing diagram illustrating an example process that supports enhanced sidelink information reporting according to one or more aspects.

FIG. 11 is a timing diagram illustrating an example process that supports enhanced sidelink information reporting according to one or more aspects.

FIG. 12 is a flow diagram illustrating an example process that supports enhanced sidelink information reporting according to one or more aspects.

FIG. 13 is a flow diagram illustrating an example process that supports enhanced sidelink information reporting according to one or more aspects.

FIG. 14 is a block diagram of an example UE that supports enhanced sidelink information reporting according to one or more aspects.

FIG. 15 is a block diagram of an example base station that supports enhanced sidelink information reporting according to one or more aspects.

Like reference numbers and designations in the various drawings indicate like elements.

### DETAILED DESCRIPTION

The detailed description set forth below, in connection with the appended, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

This disclosure relates generally to providing or participating in authorized shared access between two or more wireless devices in one or more wireless communications systems, also referred to as wireless communications networks. In various implementations, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, GSM networks, ₅th Generation (5G) or new radio (NR) networks (sometimes referred to as “5G NR” networks, systems, or devices), as well as other communications networks. As described herein, the terms “networks” and “systems” may be used interchangeably.

A CDMA network, for example, may implement a radio technology such as universal terrestrial radio access (UTRA), cdma2000, and the like. UTRA includes wideband-CDMA (W-CDMA) and low chip rate (LCR). CDMA2000 covers IS-2000, IS-95, and IS-856 standards.

A TDMA network may, for example implement a radio technology such as Global System for Mobile Communication (GSM). The 3rd Generation Partnership Project (3GPP) defines standards for the GSM EDGE (enhanced data rates for GSM evolution) radio access network (RAN), also denoted as GERAN. GERAN is the radio component of GSM/EDGE, together with the network that joins the base stations (for example, the Ater and Abis interfaces) and the base station controllers (A interfaces, etc.). The radio access network represents a component of a GSM network, through which phone calls and packet data are routed from and to the public switched telephone network (PSTN) and Internet to and from subscriber handsets, also known as user terminals or user equipments (UEs). A mobile phone operator's network may comprise one or more GERANs, which may be coupled with UTRANs in the case of a UMTS/GSM network. Additionally, an operator network may also include one or more LTE networks, or one or more other networks. The various different network types may use different radio access technologies (RATs) and RANs.

An OFDMA network may implement a radio technology such as evolved UTRA (E-UTRA), Institute of Electrical and Electronics Engineers (IEEE) 802.11, IEEE 802.16, IEEE 802.20, flash-OFDM and the like. UTRA, E-UTRA, and GSM are part of universal mobile telecommunication system (UMTS). In particular, long term evolution (LTE) is a release of UMTS that uses E-UTRA. UTRA, E-UTRA, GSM, UMTS, LTE, and NR are described in documents provided from an organization named “3rd Generation Partnership Project” (3GPP), and cdma2000 is described in documents from an organization named “3rd Generation Partnership Project 2” (3GPP2). These various radio technologies and standards are known or are being developed. For example, the 3GPP is a collaboration between groups of telecommunications associations that aims to define a globally applicable third generation (3G) mobile phone specification. 3GPP LTE is a 3GPP project which was aimed at improving UMTS mobile phone standard. The 3GPP may define specifications for the next generation of mobile networks, mobile systems, and mobile devices. The present disclosure may describe certain aspects with reference to LTE, 4G, or 5G NR technologies; however, the description is not intended to be limited to a specific technology or application, and one or more aspects described with reference to one technology may be understood to be applicable to another technology.

Additionally, one or more aspects of the present disclosure may be related to shared access to wireless spectrum between networks using different radio access technologies or radio air interfaces.

5G networks contemplate diverse deployments, diverse spectrum, and diverse services and devices that may be implemented using an OFDM-based unified, air interface. To achieve these goals, further enhancements to LTE and LTE-A are considered in addition to development of the new radio technology for 5G NR networks. The 5G NR will be capable of scaling to provide coverage (1) to a massive Internet of things (IoTs) with an ultra-high density (e.g., ˜1 M nodes/km²), ultra-low complexity (e.g., ˜10 s of bits/sec), ultra-low energy (e.g., ˜10+ years of battery life), and deep coverage with the capability to reach challenging locations; (2) including mission-critical control with strong security to safeguard sensitive personal, financial, or classified information, ultra-high reliability (e.g., ˜99.9999% reliability), ultra-low latency (e.g., ˜1 millisecond (ms)), and users with wide ranges of mobility or lack thereof; and (3) with enhanced mobile broadband including extreme high capacity (e.g., ˜10 Tbps/km²), extreme data rates (e.g., multi-Gbps rate, 100+Mbps user experienced rates), and deep awareness with advanced discovery and optimizations.

Devices, networks, and systems may be configured to communicate via one or more portions of the electromagnetic spectrum. The electromagnetic spectrum is often subdivided, based on frequency or wavelength, into various classes, bands, channels, etc. In 5G NR two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” (mmWave) band in documents and articles, despite being different from the extremely high frequency (EHF) band (30 GHz-300 GHz) which is identified by the International Telecommunications Union (ITU) as a “mmWave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “mmWave” or the like if used herein may broadly represent frequencies that may include mid-band frequencies, may be within FR2, or may be within the EHF band.

5G NR devices, networks, and systems may be implemented to use optimized OFDM-based waveform features. These features may include scalable numerology and transmission time intervals (TTIs); a common, flexible framework to efficiently multiplex services and features with a dynamic, low-latency time division duplex (TDD) design or frequency division duplex (FDD) design; and advanced wireless technologies, such as massive multiple input, multiple output (MIMO), robust mmWave transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHz FDD or TDD implementations, subcarrier spacing may occur with 15 kHz, for example over 1, 5, 10, 20 MHz, and the like bandwidth. For other various outdoor and small cell coverage deployments of TDD greater than 3 GHz, subcarrier spacing may occur with 30 kHz over 80/100 MHz bandwidth. For other various indoor wideband implementations, using a TDD over the unlicensed portion of the 5 GHz band, the subcarrier spacing may occur with 60 kHz over a 160 MHz bandwidth. Finally, for various deployments transmitting with mmWave components at a TDD of 28 GHz, subcarrier spacing may occur with 120 kHz over a 500 MHz bandwidth.

The scalable numerology of 5G NR facilitates scalable TTI for diverse latency and quality of service (QoS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with uplink or downlink scheduling information, data, and acknowledgement in the same subframe. The self-contained integrated subframe supports communications in unlicensed or contention-based shared spectrum, adaptive uplink or downlink that may be flexibly configured on a per-cell basis to dynamically switch between uplink and downlink to meet the current traffic needs.

For clarity, certain aspects of the apparatus and techniques may be described below with reference to example 5G NR implementations or in a 5G-centric way, and 5G terminology may be used as illustrative examples in portions of the description below; however, the description is not intended to be limited to 5G applications.

Moreover, it should be understood that, in operation, wireless communication networks adapted according to the concepts herein may operate with any combination of licensed or unlicensed spectrum depending on loading and availability. Accordingly, it will be apparent to a person having ordinary skill in the art that the systems, apparatus and methods described herein may be applied to other communications systems and applications than the particular examples provided.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements, etc. For example, implementations or uses may come about via integrated chip implementations or other non-module-component based devices (e.g., end-user devices, vehicles, communication devices, computing devices, industrial equipment, retail devices or purchasing devices, medical devices, AI-enabled devices, etc.). While some examples may or may not be specifically directed to use cases or applications, a wide assortment of applicability of described innovations may occur. Implementations may range from chip-level or modular components to non-modular, non-chip-level implementations and further to aggregated, distributed, or original equipment manufacturer (OEM) devices or systems incorporating one or more described aspects. In some practical settings, devices incorporating described aspects and features may also necessarily include additional components and features for implementation and practice of claimed and described aspects. It is intended that innovations described herein may be practiced in a wide variety of implementations, including both large devices or small devices, chip-level components, multi-component systems (e.g., radio frequency (RF)-chain, communication interface, processor), distributed arrangements, aggregated or dis-aggregated deployments, end-user devices, etc. of varying sizes, shapes, and constitution.

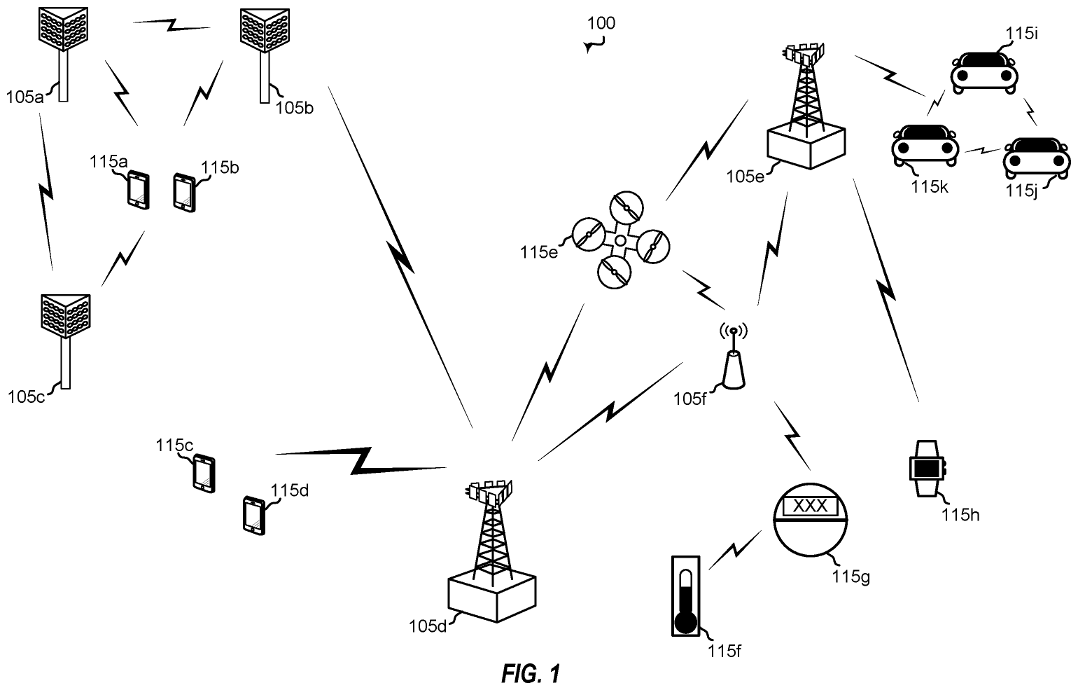

FIG. 1 is a block diagram illustrating details of an example wireless communication system according to one or more aspects. The wireless communication system may include wireless network 100. Wireless network 100 may, for example, include a 5G wireless network. As appreciated by those skilled in the art, components appearing in FIG. 1 are likely to have related counterparts in other network arrangements including, for example, cellular-style network arrangements and non-cellular-style-network arrangements (e.g., device to device or peer to peer or ad hoc network arrangements, etc.).

Wireless network 100 illustrated in FIG. 1 includes a number of base stations 105 and other network entities. A base station may be a station that communicates with one or more UEs and may also be referred to as an evolved node B (eNB), a next generation eNB (gNB), an access point, and the like. Each base station 105 may provide communication coverage for a particular geographic area. In 3GPP, the term “cell” may refer to this particular geographic coverage area of a base station or a base station subsystem serving the coverage area, depending on the context in which the term is used.

In implementations of wireless network 100 herein, base stations 105 may be associated with a same operator or different operators (e.g., wireless network 100 may include a plurality of operator wireless networks). Additionally, in implementations of wireless network 100 herein, base station 105 may provide wireless communications using one or more of the same frequencies (e.g., one or more frequency bands in licensed spectrum, unlicensed spectrum, or a combination thereof) as a neighboring cell. In some examples, an individual base station 105 or UE 115 may be operated by more than one network operating entity. In some other examples, each base station 105 and UE 115 may be operated by a single network operating entity.

A base station may provide communication coverage for a macro cell or a small cell, such as a pico cell or a femto cell, or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A base station for a macro cell may be referred to as a macro base station. A base station for a small cell may be referred to as a small cell base station, a pico base station, a femto base station or a home base station. In the example shown in FIG. 1, base stations 105d and 105e are regular macro base stations, while base stations 105a-105c are macro base stations enabled with one of 3 dimension (3D), full dimension (FD), or massive MIMO. Base stations 105a-105c take advantage of their higher dimension MIMO capabilities to exploit 3D beamforming in both elevation and azimuth beamforming to increase coverage and capacity. Base station 105f is a small cell base station which may be a home node or portable access point. A base station may support one or multiple (e.g., two, three, four, and the like) cells.

Wireless network 100 may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. In some scenarios, networks may be enabled or configured to handle dynamic switching between synchronous or asynchronous operations.

UEs 115 are dispersed throughout the wireless network 100, and each UE may be stationary or mobile. It should be appreciated that, although a mobile apparatus is commonly referred to as a UE in standards and specifications promulgated by the 3GPP, such apparatus may additionally or otherwise be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, a gaming device, an augmented reality device, vehicular component, vehicular device, or vehicular module, or some other suitable terminology. Within the present document, a “mobile” apparatus or UE need not necessarily have a capability to move, and may be stationary. Some non-limiting examples of a mobile apparatus, such as may include implementations of one or more of UEs 115, include a mobile, a cellular (cell) phone, a smart phone, a session initiation protocol (SIP) phone, a wireless local loop (WLL) station, a laptop, a personal computer (PC), a notebook, a netbook, a smart book, a tablet, and a personal digital assistant (PDA). A mobile apparatus may additionally be an IoT or “Internet of everything” (IoE) device such as an automotive or other transportation vehicle, a satellite radio, a global positioning system (GPS) device, a global navigation satellite system (GNSS) device, a logistics controller, a drone, a multi-copter, a quad-copter, a smart energy or security device, a solar panel or solar array, municipal lighting, water meter, or other infrastructure; industrial automation and enterprise devices; consumer and wearable devices, such as eyewear, a wearable camera, a smart watch, a health or fitness tracker, a mammal implantable device, gesture tracking device, medical device, a digital audio player (e.g., MP3 player), a camera, a game console, etc.; and digital home or smart home devices such as a home audio, video, and multimedia device, an appliance, a sensor, a vending machine, intelligent lighting, a home security system, a smart meter, etc. In one aspect, a UE may be a device that includes a Universal Integrated Circuit Card (UICC). In another aspect, a UE may be a device that does not include a UICC. In some aspects, UEs that do not include UICCs may also be referred to as IoE devices. UEs 115a-115d of the implementation illustrated in FIG. 1 are examples of mobile smart phone-type devices accessing wireless network 100 A UE may also be a machine specifically configured for connected communication, including machine type communication (MTC), enhanced MTC (eMTC), narrowband IoT (NB-IoT) and the like.

UEs 115e-115k illustrated in FIG. 1 are examples of various machines configured for communication that access wireless network 100.

A mobile apparatus, such as UEs 115, may be able to communicate with any type of the base stations, whether macro base stations, pico base stations, femto base stations, relays, and the like. In FIG. 1, a communication link (represented as a lightning bolt) indicates wireless transmissions between a UE and a serving base station, which is a base station designated to serve the UE on the downlink or uplink, or desired transmission between base stations, and backhaul transmissions between base stations. UEs may operate as base stations or other network nodes in some scenarios. Backhaul communication between base stations of wireless network 100 may occur using wired or wireless communication links.

In operation at wireless network 100, base stations 105a-105c serve UEs 115a and 115b using 3D beamforming and coordinated spatial techniques, such as coordinated multipoint (CoMP) or multi-connectivity. Macro base station 105d performs backhaul communications with base stations 105a-105c, as well as small cell, base station 105f. Macro base station 105d also transmits multicast services which are subscribed to and received by UEs 115c and 115d. Such multicast services may include mobile television or stream video, or may include other services for providing community information, such as weather emergencies or alerts, such as Amber alerts or gray alerts.

Wireless network 100 of implementations supports mission critical communications with ultra-reliable and redundant links for mission critical devices, such UE 115e, which is a drone. Redundant communication links with UE 115e include from macro base stations 105d and 105e, as well as small cell base station 105f. Other machine type devices, such as UE 115f (thermometer), UE 115g (smart meter), and UE 115h (wearable device) may communicate through wireless network 100 either directly with base stations, such as small cell base station 105f, and macro base station 105e, or in multi-hop configurations by communicating with another user device which relays its information to the network, such as UE 115f communicating temperature measurement information to the smart meter, UE 115g, which is then reported to the network through small cell base station 105f. Wireless network 100 may also provide additional network efficiency through dynamic, low-latency TDD communications or low-latency FDD communications, such as in a vehicle-to-vehicle (V2V) mesh network between UEs 115i-115k communicating with macro base station 105e.

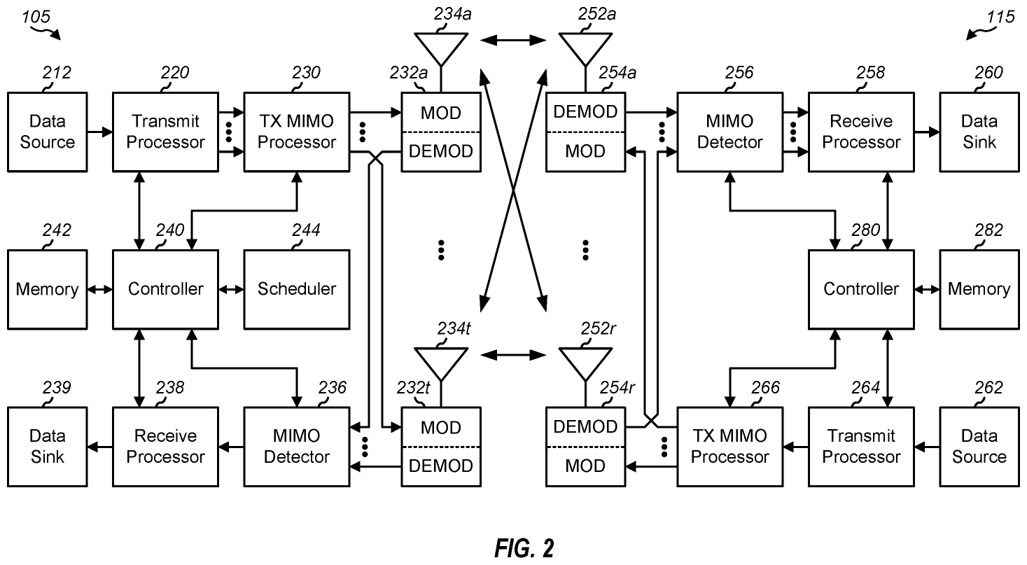

FIG. 2 is a block diagram illustrating examples of base station 105 and UE 115 according to one or more aspects. Base station 105 and UE 115 may be any of the base stations and one of the UEs in FIG. 1. For a restricted association scenario (as mentioned above), base station 105 may be small cell base station 105f in FIG. 1, and UE 115 may be UE 115c or 115d operating in a service area of base station 105f, which in order to access small cell base station 105f, would be included in a list of accessible UEs for small cell base station 105f. Base station 105 may also be a base station of some other type. As shown in FIG. 2, base station 105 may be equipped with antennas 234a through 234t, and UE 115 may be equipped with antennas 252a through 252r for facilitating wireless communications.

At base station 105, transmit processor 220 may receive data from data source 212 and control information from controller 240, such as a processor. The control information may be for a physical broadcast channel (PBCH), a physical control format indicator channel (PCFICH), a physical hybrid-ARQ (automatic repeat request) indicator channel (PHICH), a physical downlink control channel (PDCCH), an enhanced physical downlink control channel (EPDCCH), an MTC physical downlink control channel (MPDCCH), etc. The data may be for a physical downlink shared channel (PDSCH), etc. Additionally, transmit processor 220 may process (e.g., encode and symbol map) the data and control information to obtain data symbols and control symbols, respectively. Transmit processor 220 may also generate reference symbols, e.g., for the primary synchronization signal (PSS) and secondary synchronization signal (SSS), and cell-specific reference signal.

Transmit (TX) MIMO processor 230 may perform spatial processing (e.g., precoding) on the data symbols, the control symbols, or the reference symbols, if applicable, and may provide output symbol streams to modulators (MODs) 232a through 232t. For example, spatial processing performed on the data symbols, the control symbols, or the reference symbols may include precoding. Each modulator 232 may process a respective output symbol stream (e.g., for OFDM, etc.) to obtain an output sample stream. Each modulator 232 may additionally or alternatively process (e.g., convert to analog, amplify, filter, and upconvert) the output sample stream to obtain a downlink signal. Downlink signals from modulators 232a through 232t may be transmitted via antennas 234a through 234t, respectively.

At UE 115, antennas 252a through 252r may receive the downlink signals from base station 105 and may provide received signals to demodulators (DEMODs) 254a through 254r, respectively. Each demodulator 254 may condition (e.g., filter, amplify, downconvert, and digitize) a respective received signal to obtain input samples. Each demodulator 254 may further process the input samples (e.g., for OFDM, etc.) to obtain received symbols. MIMO detector 256 may obtain received symbols from demodulators 254a through 254r, perform MIMO detection on the received symbols if applicable, and provide detected symbols. Receive processor 258 may process (e.g., demodulate, deinterleave, and decode) the detected symbols, provide decoded data for UE 115 to data sink 260, and provide decoded control information to controller 280, such as a processor.

On the uplink, at UE 115, transmit processor 264 may receive and process data (e.g., for a physical uplink shared channel (PUSCH)) from data source 262 and control information (e.g., for a physical uplink control channel (PUCCH)) from controller 280. Additionally, transmit processor 264 may also generate reference symbols for a reference signal. The symbols from transmit processor 264 may be precoded by TX MIMO processor 266 if applicable, further processed by modulators 254a through 254r (e.g., for SC-FDM, etc.), and transmitted to base station 105. At base station 105, the uplink signals from UE 115 may be received by antennas 234, processed by demodulators 232, detected by MIMO detector 236 if applicable, and further processed by receive processor 238 to obtain decoded data and control information sent by UE 115. Receive processor 238 may provide the decoded data to data sink 239 and the decoded control information to controller 240.

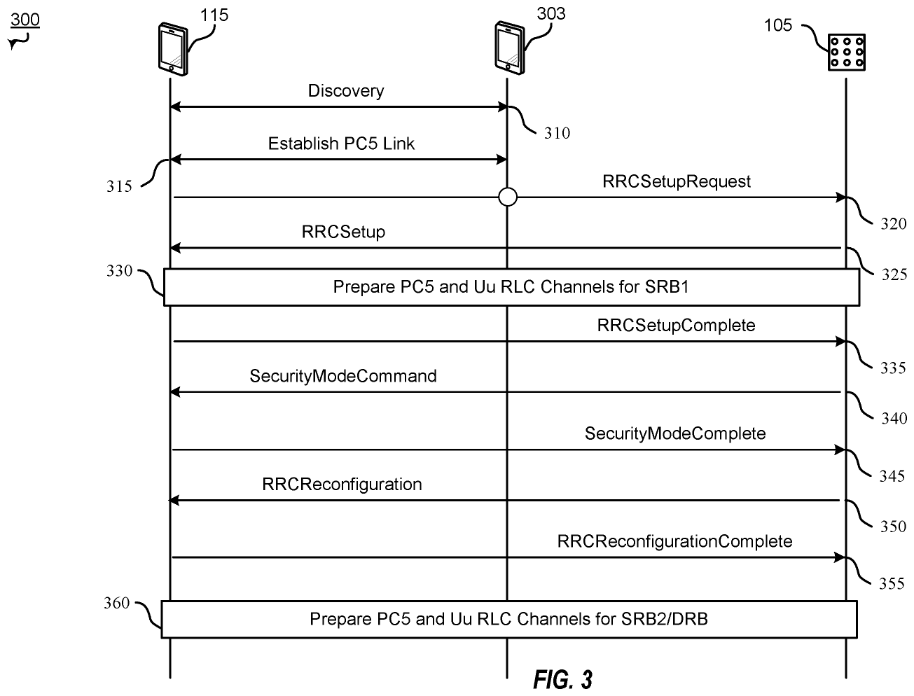

Controllers 240 and 280 may direct the operation at base station 105 and UE 115, respectively. Controller 240 or other processors and modules at base station 105 or controller 280 or other processors and modules at UE 115 may perform or direct the execution of various processes for the techniques described herein, such as to perform or direct the execution illustrated in FIGS. 3-13, or other processes for the techniques described herein. Memories 242 and 282 may store data and program codes for base station 105 and UE 115, respectively. Scheduler 244 may schedule UEs for data transmission on the downlink or the uplink.

In some cases, UE 115 and base station 105 may operate in a shared radio frequency spectrum band, which may include licensed or unlicensed (e.g., contention-based) frequency spectrum. In an unlicensed frequency portion of the shared radio frequency spectrum band, UEs 115 or base stations 105 may traditionally perform a medium-sensing procedure to contend for access to the frequency spectrum. For example, UE 115 or base station 105 may perform a listen-before-talk or listen-before-transmitting (LBT) procedure such as a clear channel assessment (CCA) prior to communicating in order to determine whether the shared channel is available. In some implementations, a CCA may include an energy detection procedure to determine whether there are any other active transmissions. For example, a device may infer that a change in a received signal strength indicator (RSSI) of a power meter indicates that a channel is occupied. Specifically, signal power that is concentrated in a certain bandwidth and exceeds a predetermined noise floor may indicate another wireless transmitter. A CCA also may include detection of specific sequences that indicate use of the channel. For example, another device may transmit a specific preamble prior to transmitting a data sequence. In some cases, an LBT procedure may include a wireless node adjusting its own backoff window based on the amount of energy detected on a channel or the acknowledge/negative-acknowledge (ACK/NACK) feedback for its own transmitted packets as a proxy for collisions.

Deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

FIG. 3 illustrates an example of connection establishment operations. In FIG. 3, connection establishment operations are shown for a UE (e.g., remote UE) establishing multiple connections with another UE and a network device. FIG. 3 illustrates a timing diagram of connection establishment operations for a UE 115 (e.g., a first UE or relay UE), a second UE 303 (e.g., a second UE or relay UE), and a base station 105. The devices may engage in half and/or full-duplex operations. Full-duplex operations corresponds to transmitting and/or receiving data via multiple antennas at the same time. Half-duplex operation corresponds to transmitting or receiving data via a single antenna at a particular time.

UEs and network devices, such as UE 115 and the second UE 303, and the base station 105 may establish a uplink/downlink communication links (e.g., a Uu communication link), the UE 115 and the second UE 303 may each communicate with the base station 105 over the Uu communication link by transmitting and/or receiving transmissions.

UEs, such as UE 115 and the second UE 303, may establish a PC5 communication link (e.g., a SL communication link), the UE 115 and the second UE 303 may communicate with each other over the PC5 communication link by transmitting and/or receiving transmissions. For example, the PC5 link between the UE 115 and the second UE 303 may enable the UE 115 to connect or communicate with the base station 105, even if the UE 115 is considered a remote UE to the base station 105 and is located out of range of the base station 105 or outside of its coverage area. The PC5 link may enable relay communications, such as communications from the base station 105 or the UE 115 to be relayed to one another via the second UE 303. For example, a communication may be transmitted by sidelink from the UE 115 to the second UE 303 and then relayed to the base station 105 via uplink.

During operation, at 310, the UE 115, the second UE 303, or both may perform device discovery, such as sidelink device discovery. This may include broadcasting setup and/or system information messages, and may include receiving and responding the messages.

At 320, the UE 115 transmits a connection establishment request to the base station 105 via the second UE 303. For example, the UE 115 may transmit a higher layer message or transmission requesting to perform connection establishment operations responsive to and based on the discovery operations performed (e.g., receipt of system information).

At 325, the base station 105 transmits a connection establishment setup message to the UE 115 via the second UE 303. For example, the base station 105 transmits a connection establishment message responsive to the connection establishment request message.

At 330, the base station 105, the UE 115, and/or the second UE 303 prepare the communication links RLC channels for SRB1. For example, the base station 105, the UE 115, and/or the second UE 303 prepare the RLC channels for SRB1 based on the connection establishment request and complete messages.

At 335, the UE 115 transmits a connection establishment complete message to the base station 105 via the second UE 303. For example, the UE 115 may transmit a higher layer message or transmission indicating successful completion of connection establishment operations or failure of connection establishment operations responsive to and based on the connection establishment request message, a received SRB1, and/or preparing the communication links RLC channels for SRB1.

At 340, the base station 105 transmits a security mode command message to the UE 115 via the second UE 303. For example, the base station 105 may transmit a higher layer message or transmission indicating a security mode command, such as uncyphered message with integrity protection with a security context (e.g., 5G NAS security context).

At 345, the UE 115 transmits a security mode command complete message to the base station 105 via the second UE 303. For example, the UE 115 may transmit a higher layer message or transmission indicating a security mode command complete, such as cyphered message with integrity protection based on the received security context (e.g., 5G NAS security context).

At 350, the base station 105 transmits a reconfiguration message to the UE 115 via the second UE 303. For example, the base station 105 may transmit a higher layer message or transmission indicating a RRC configuration for the UE 115, such as RRCReconfiguration message.

At 355, the UE 115 transmits a reconfiguration complete message to the base station 105 via the second UE 303. For example, the UE 115 may transmit a higher layer message or transmission indicating a RRC reconfiguration has been completed, such as RRCReconfigurationComplete message.

At 360, the base station 105, the UE 115, and/or the second UE 303 prepare the communication links RLC channels for SRB2/DRB. For example, the base station 105, the UE 115, and/or the second UE 303 prepare the RLC channels for SRB2/DRB based on the RRC configuration and/or RRC configuration complete messages.

After establishment of the connections (also referred to as a link or communication link), the devices may operate using the connections. During operations, one or more of the connections may fail or be switched (e.g., by a handover operation) for mobility scenarios (e.g., when a device moves around and goes out of coverage from one device and moves into coverage of another device). For examples regarding failures, a device may experience a radio link failure, a beam failure, or even a connection establishment failure during one of the operations of FIG. 3.

When a device that is connected to a base station experiences a failure with the connection to the base station, the device may send a failure report to the base station directly with information about the failure and/or with information to recover from the failure, such as beam failure reports, radio link failure reports, etc.

When a device that is connected to a base station and directly to another device experiences a failure with the connection to the other device or the base station, the device may send a failure report to the base station directly with information about the failure and/or with information to recover from the failure, such as beam failure reports, radio link failure reports, etc. In Release-16, a UE can report to the network that a sidelink radio link failure or sidelink RRC reconfiguration failure has been declared using SidelinkUEInformationNR message over the Uu link for each other UE (e.g., destination) for which it encounters the NR sidelink communication failure.

In Release-16, the SidelinkUEInformationNR message includes two fields, a SL-DestinationIdentity-r16 (UE2) field and a s1-failure-r16 field. The SL-DestinationIdentity-r16 (UE2) field indicates the UE where the sidelink RLF was detected, such as indicates the sidelink AS configuration failure (value configFailure) for the associated destination in case of a PC5-RRC AS configuration failure by receiving RRCReconfigurationFailureSidelink. The sl-Failure field indicates the sidelink RLF (value rlf) for the associated destination, when the sidelink RLF is detected.

Currently, the sidelink reporting information is limited, especially in cases where a remote UE connects to the base station via a relay UE. The sidelink reporting information does not include information to help with cell reselection or mobility operations. The sidelink reporting information can be enhanced to help with cell reselection, mobility operations, or both. For example, the sidelink reporting information can be enhanced with location information and/or failure cause information to help with cell reselection and/or mobility operations.

When a remote device that is connected to a base station through a relay device and does not have its own direct connection to the base station experiences a failure with either connection, the device currently has no reporting options. Accordingly, new reports and reporting methods (e.g., enhanced reports and schemes) are disclosed herein to enable reporting in advanced indirect connection and relay connection operations.

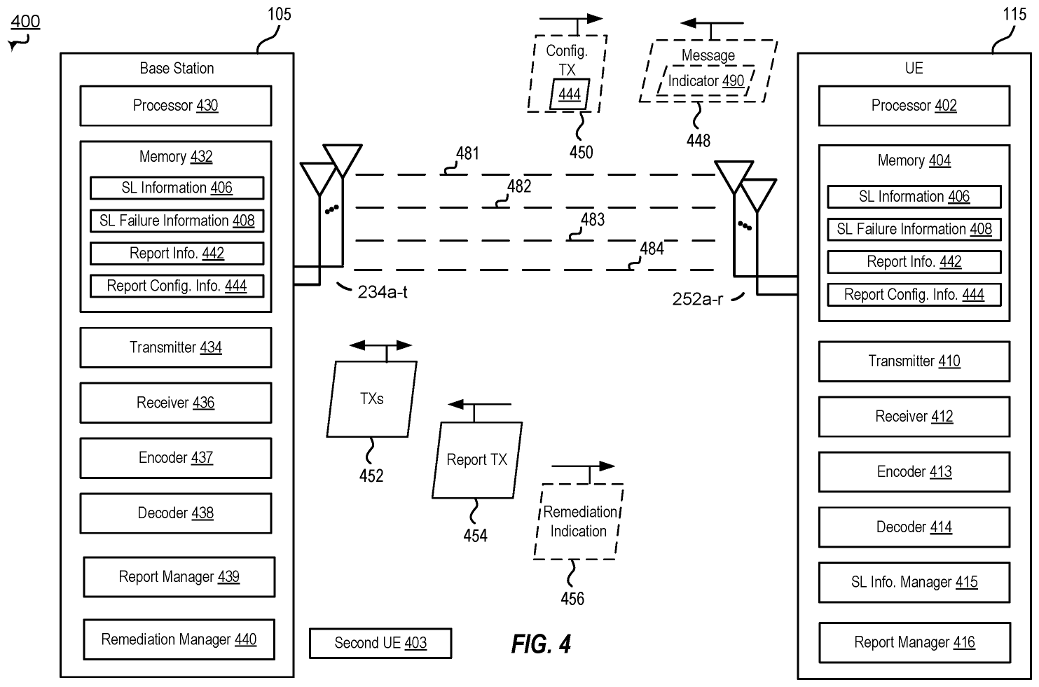

FIG. 4 illustrates an example of a wireless communications system 400 that supports enhanced sidelink information reporting in accordance with aspects of the present disclosure. In some examples, wireless communications system 400 may implement aspects of wireless communication system 100. For example, wireless communications system 400 may include a network, such as one or more network entities, and one or more UEs, such as UE 115 (also referred to as a first UE and optionally operating as a remote UE at times) and second UE 403 (optionally operating as a relay UE at times). As illustrated in the example of FIG. 4, the network entity includes a corresponds to a base station, such as base station 105. Alternatively, the network entity may include or correspond to a different network device (e.g., not a base station). Enhanced sidelink information reporting may reduce failures, such as beam failure, radio link failures, connection establishment failures, etc. and enable improved selection or reselection and handover operations. These improvements may reduce latency and increase throughput by improving connection quality and reducing interference and failures. Accordingly, network and device performance can be increased.

Base station 105, UE 115, and second UE 403 may be configured to communicate via one or more portions of the electromagnetic spectrum. The electromagnetic spectrum is often subdivided, based on frequency/wavelength, into various classes, bands, channels, etc. In 5G NR two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “mmWave” band in documents and articles, despite being different from the extremely high frequency (EHF) band (30 GHz-300 GHz) which is identified by the International Telecommunications Union (ITU) as a “mmWave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “mmWave” or the like if used herein may broadly represent frequencies that may include mid-band frequencies, may be within FR2, or may be within the EHF band.

It is noted that SCS may be equal to 15, 30, 60, or 120 kHz for some data channels. Base station 105 and UE 115 may be configured to communicate via one or more component carriers (CCs), such as representative first CC 481, second CC 482, third CC 483, and fourth CC 484. Although four CCs are shown, this is for illustration only, more or fewer than four CCs may be used. One or more CCs may be used to communicate control channel transmissions, data channel transmissions, and/or sidelink channel transmissions.

Such transmissions may include a Physical Downlink Control Channel (PDCCH), a Physical Downlink Shared Channel (PDSCH), a Physical Uplink Control Channel (PUCCH), a Physical Uplink Shared Channel (PUSCH), a Physical Sidelink Control Channel (PSCCH), a Physical Sidelink Shared Channel (PSSCH), or a Physical Sidelink Feedback Channel (PSFCH). Such transmissions may be scheduled by aperiodic grants and/or periodic grants.

Each periodic grant may have a corresponding configuration, such as configuration parameters/settings. The periodic grant configuration may include configured grant (CG) configurations and settings. Additionally, or alternatively, one or more periodic grants (e.g., CGs thereof) may have or be assigned to a CC ID, such as intended CC ID.

Each CC may have a corresponding configuration, such as configuration parameters/settings. The configuration may include bandwidth, bandwidth part, HARQ process, TCI state, RS, control channel resources, data channel resources, or a combination thereof. Additionally, or alternatively, one or more CCs may have or be assigned to a Cell ID, or a Bandwidth Part (BWP) ID. The Cell ID may include a unique cell ID for the CC, a virtual Cell ID, or a particular Cell ID of a particular CC of the plurality of CCs. Additionally, or alternatively, one or more CCs may have or be assigned to a HARQ ID. Each CC may also have corresponding management functionalities, such as, beam management or BWP switching functionality. In some implementations, two or more CCs are quasi co-located, such that the CCs have the same beam and/or same symbol.

In some implementations, control information may be communicated via base station 105, UE 115, and second UE 403. For example, the control information may be communicated suing MAC-CE transmissions, RRC transmissions, DCI (downlink control information) transmissions, UCI (uplink control information) transmissions, SCI (sidelink control information) transmissions, another transmission, or a combination thereof.

UE 115 can include a variety of components (e.g., structural, hardware components) used for carrying out one or more functions described herein. For example, these components can includes processor 402, memory 404, transmitter 410, receiver 412, encoder, 413, decoder 414, sidelink information manager 415, report manager 416, and antennas 252a-r. Processor 402 may be configured to execute instructions stored at memory 404 to perform the operations described herein. In some implementations, processor 402 includes or corresponds to controller/processor 280, and memory 404 includes or corresponds to memory 282. Memory 404 may also be configured to store sidelink information 406, sidelink radio link failure information 408, sidelink report information 442, report configuration information 444, settings data, or a combination thereof, as further described herein.

The sidelink information 406 includes or corresponds to data associated with or corresponding to sidelink operations, and may be referred to as sidelink related information or sidelink operations information. For example, the sidelink information 406 may include sidelink activity or operations information, sidelink radio link failure information (e.g., sidelink radio link failure information 408), sidelink mobility history information, sidelink connection establishment information, sidelink RACH information, sidelink location information, sidelink position information, or a combination thereof. As another example, the sidelink information 406 may be used to generate sidelink report information 442 or additional sidelink information 406. The sidelink information 406 may be stored in one or more variables, such as SL variables, RLF variables, RACH report variables, etc. Additionally, or alternatively, the sidelink information 406 may include sidelink information for multiple serving cells, multiple subbands, multiple BWPs, multiple sidelink UEs, or a combination thereof.

The sidelink failure information, also referred to as sidelink radio link failure information 408 includes or corresponds to data associated with or corresponding to determine sidelink failures and/or radio link failure events or instances. For example, the sidelink radio link failure information 408 may include radio link failure cause information, sidelink mobility history information, sidelink connection establishment information, sidelink RACH information, sidelink location information, sidelink position information, or a combination thereof. The sidelink radio link failure information 408 may include information regarding sidelink link radio link failures and information regarding sidelink operations or activity while experiencing other failures (e.g., Uu link failure, CEF, relay selection failure, handover failure etc.). As another example, the sidelink radio link failure information 408 may be used to generate the sidelink report information 442 or additional sidelink information 406. The sidelink radio link failure information 408 may be stored in one or more variables, such as SL variables, RLF variables, RACH report variables, etc. Additionally, or alternatively, the sidelink radio link failure information 408 may include sidelink information for multiple serving cells, multiple subbands, multiple BWPs, multiple sidelink UEs, or a combination thereof.

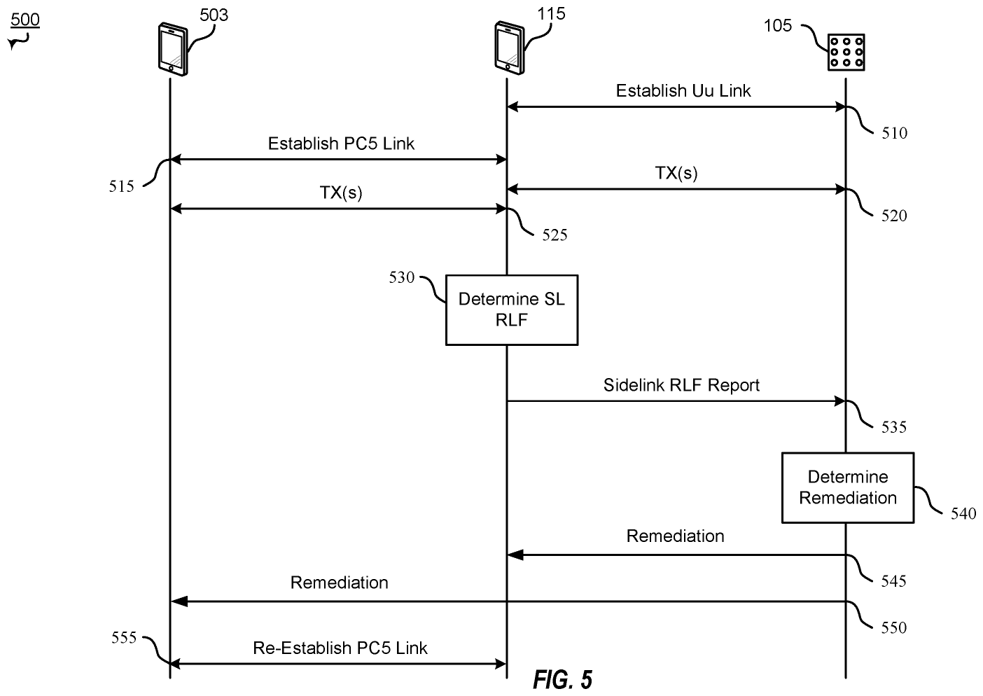

The sidelink report information 442 (alternatively referred to as just report information 442) includes or corresponds to data associated with or corresponding to sidelink reports and report transmissions for sidelink operations. For example, the sidelink report information 442 may include or correspond to one or more sidelink reports transmitted over sidelink or uplink. A sidelink report may include or be generated based on the sidelink information 406, the sidelink radio link failure information 408, or both. To illustrate, a sidelink report may include an indication of a cause of SL radio link failure, as described further with reference to FIG. 5. Additionally, or alternatively, the UE 115 may include other report information, such as RACH report information, CEF report information, MHR information, or a combination thereof. Each of the other reports may include or be generated based on the sidelink information 406, the sidelink radio link failure information 408, or both.

The report configuration information 444 includes or corresponds to data indicating or corresponding to sidelink report configurations. For example, the report configuration information 444 may include or correspond to report timing information, report type information, report format information, report history length, report resource information, report threshold information, reports per serving cell information, bandwidth part information, subband information, or a combination thereof.

The settings data includes or corresponds to data associated with enhanced sidelink information reporting operations. The settings data may include one or more types of enhanced sidelink information reporting operation modes and/or thresholds or conditions for switching between enhanced sidelink information reporting modes and/or configurations thereof. For example, the settings data may have data indicating different thresholds and/or conditions for different enhanced sidelink information reporting modes, such as a which pieces of sidelink information to send, in what report to send the sidelink information, push sidelink information reporting, pull sidelink information reporting, etc., or a combination thereof.

The UE 115 may further include location information data, position information data, and/or sensor information data. For example, location information data may indicate a location of a device, such as global or absolute position in a cell or network, or a location from a specific reference point. The location information data may be generated based on the position information data and the sensor information data. For example, the location information data may be generated based on a position (e.g., satellite GPS or GNSS position, WLAN position, Bluetooth position, or a combination thereof) indicated by the position information data and refined or adjusted based on the sensor information data. To illustrate, a position or multiple positions may be aggregated and then adjusted based accelerometer data, barometer data, inertial sensor data, temperature data, speed data, compass data, Bluetooth operations data, WLAN operations data, etc. The location information data, position information data, and/or sensor information data may be included in the report information 442 in some implementations, such as part of the sidelink information (e.g., 406) or sidelink failure information (e.g., 408).

Transmitter 410 is configured to transmit data to one or more other devices, and receiver 412 is configured to receive data from one or more other devices. For example, transmitter 410 may transmit data, and receiver 412 may receive data, via a network, such as a wired network, a wireless network, or a combination thereof. For example, UE 115 may be configured to transmit and/or receive data via a direct device-to-device connection, a local area network (LAN), a wide area network (WAN), a modem-to-modem connection, the Internet, intranet, extranet, cable transmission system, cellular communication network, any combination of the above, or any other communications network now known or later developed within which permits two or more electronic devices to communicate. In some implementations, transmitter 410 and receiver 412 may be replaced with a transceiver. Additionally, or alternatively, transmitter 410 or receiver, 412 may include or correspond to one or more components of UE 115 described with reference to FIG. 2.

Encoder 413 and decoder 414 may be configured to encode and decode data for transmission. Sidelink information manager 415 may be configured to perform CLI determination and reporting operations. For example, sidelink information manager 415 may be configured to determine and/or measure sidelink information for sidelink information reporting. To illustrate, the sidelink information manager 415 may be configured to determine information 406, sidelink radio link failure information 408, or both. Optionally, the sidelink information manager 415 may be configured to derive particular pieces of sidelink information or sidelink radio link failure information from measured, obtained, or determined sidelink information and/or sidelink radio link failure information. As an example, the sidelink information manager 415 may derive or determine the location information from position information and sensor information, and optionally other network operation information (e.g., Bluetooth and/or WLAN, such as WiFi). Additionally, or alternatively, the sidelink information manager 415 may be configured to store or manage the sidelink information 406, sidelink radio link failure information 408, or both in one or more variables.

Report manager 416 (e.g., sidelink report manager) may be configured to perform sidelink information reporting operations, such as report configuration, report generation, and report transmission. For example, report manager 416 may be configured to generate the sidelink reporting information 442 based on the sidelink information 406, sidelink radio link failure information 408, or both, according to a report configuration indicated by the report configuration information 444.

Second UE 403 may include one or more elements similar to UE 115. In some implementations, the second UE 403 is in coverage for the base station 105. In some such implementations, the second UE 403 may act as a relay UE for the UE 115. In other implementations, the second UE 403 is out of coverage for the base station 105, and the second UE 403 may optionally be connected to the base station 105 via the UE 115.

In some implementations, the UE 115 and the second UE 403 are different types of UEs. For example, either UE may be a higher quality or have different operating constraints. To illustrate, one of the UEs may have a larger form factor or be a current generation device, and thus have more advanced capabilities and/or reduced battery constraints, higher processing constraints, etc.

Base station 105 includes processor 430, memory 432, transmitter 434, receiver 436, encoder 437, decoder 438, report manager 439, remediation manager 440, and antennas 234a-t. Processor 430 may be configured to execute instructions stores at memory 432 to perform the operations described herein. In some implementations, processor 430 includes or corresponds to controller/processor 240, and memory 432 includes or corresponds to memory 242. Memory 432 may be configured to store sidelink information 406, sidelink radio link failure information 408, sidelink report information 442, report configuration information 444, settings data, or a combination thereof, similar to the UE 115 and as further described herein.

Transmitter 434 is configured to transmit data to one or more other devices, and receiver 436 is configured to receive data from one or more other devices. For example, transmitter 434 may transmit data, and receiver 436 may receive data, via a network, such as a wired network, a wireless network, or a combination thereof. For example, UEs and/or base station 105 may be configured to transmit and/or receive data via a direct device-to-device connection, a local area network (LAN), a wide area network (WAN), a modem-to-modem connection, the Internet, intranet, extranet, cable transmission system, cellular communication network, any combination of the above, or any other communications network now known or later developed within which permits two or more electronic devices to communicate. In some implementations, transmitter 434 and receiver 436 may be replaced with a transceiver. Additionally, or alternatively, transmitter 434 or receiver, 436 may include or correspond to one or more components of UE 115 described with reference to FIG. 2.

Encoder 437, and decoder 438 may include the same functionality as described with reference to encoder 413 and decoder 414, respectively. Report manager 439 may include similar functionality as described with reference to report manager 416. Remediation manager 440 may be configured to determine failure remediation operations and perform failure remediation operations. For example, the remediation manager 440 may be configured to determine a remediation action for a base station device or a UE to recover from a beam failure, radio link failure, connection failure, handover failure, etc. As another example, the remediation manager 440 may be configured to provide the remediation determination to one or more other devices.

During operation of wireless communications system 400, the network (e.g., base station 105) may determine that UE 115 has enhanced sidelink information reporting capability. For example, UE 115 may transmit a message 448 that includes an enhanced sidelink information reporting indicator 490 (e.g., an enhanced sidelink information reporting capability indicator). Indicator 490 may indicate enhanced sidelink information reporting capability for one or more communication modes, such as downlink, uplink, sidelink, relay link, etc., or for a particular type of report (RLF report, BFR, RACH report, MHR, CEF report, or a combination thereof). In some implementations, a network entity (e.g., a base station 105) sends control information to indicate to UE 115 that enhanced sidelink information reporting operation and/or a particular type of enhanced sidelink information reporting operation is to be used. For example, in some implementations, configuration transmission 450 is transmitted to the UE 115. The configuration transmission 450 may include or indicate to use enhanced sidelink information reporting operations or to adjust or implement a setting of a particular type of enhanced sidelink information reporting operation. For example, the configuration transmission 450 may include report configuration information 444, as indicated in the example of FIG. 4, settings data or any combination thereof.

During operation, devices of wireless communications system 400 perform enhanced CLI sidelink information reporting operations. For example, the network and UEs may exchange transmissions via uplink, downlink, and/or sidelink communications over the communication links and engage in enhanced sidelink information reporting as illustrated in the example of FIG. 4. This enhanced sidelink information reporting enables devices to better maintain active or current communication links and enable better recovery from operational failures. The enhanced sidelink information reporting may be achieved by reporting sidelink information in new reports or as enhanced versions of legacy reports, e.g., Release 16 reports or proposed reports for later Releases. These enhanced sidelink information and corresponding reports may provide additional information for sidelink operations, including support of relay UE operations and/or remote UE operations.

In the example of FIG. 4, the devices of the network may engage in one or more first transmissions 452. For example, one or more of the base station 105, the UE 115, and/or the second UE 403 may each transmit or receive a transmission of the first transmissions 452. In some implementations, the UE 115 is monitoring for one or more transmissions of the first transmissions 452. The operations of the devices of the network may cause devices of the network, such as UE 115, to experience failures. In the example of FIG. 4, the UE 115 experiences a sidelink related failure associate with the first transmissions 452. The UE 115 determines sidelink information 406 based on one or more of the first transmissions 452, such as based on sidelink transmission of the first transmission 452 with the second UE 403. The first transmissions 452 may include or correspond to broadcast message, a RRC message, a DCI transmission, a PDCCH, a PDSCH, a PUCCH, a PUSCH, a PSCCH, a PSSCH, a SCI, a SL-MAC-CE, or a SL-RRC message. Alternatively, the UE 115 may experience a Uu (UL/DL) related failure associate with the first transmissions 452 and the base station 105 or a relay related failure associated with a relayed Uu link with the base station 105 via the second UE 403. Examples of such additional failures and operations for enhanced sidelink information reporting are described further with reference to FIGS. 5-11.

The UE 115 generates sidelink report information 442 based on the sidelink information 406 and/or the sidelink radio link failure information 408, and the UE 115 transmits the sidelink report information 442 in a report transmission 454 (e.g., a sidelink radio link failure report transmission) to the base station 105. For example, the UE 115 reports sidelink information for one or more sidelink radio link failures (e.g., including the sidelink radio link failure with the second UE 403) and/or sidelink operations information during other failures in the report transmission 454. The report transmission 454 may include multiple sidelink reports, and each sidelink report may correspond to sidelink information 406 or sidelink radio link failure information 408. To illustrate, the UE 115 may report one or more sidelink reports per sidelink UE and/or serving cell. The UE 115 may determine a configuration or layout of the report transmission 454 based on the report configuration information 444. Examples of report transmissions and report transmission schemes are described further with reference to FIGS. 5-11.

The base station 105 receives the report transmission 454. The base station 105, such as the remediation manager 440 thereof, may optionally determine one or more remediation actions based on the report information 442 (e.g., sidelink information 406 and/or sidelink radio link failure information 408) of the report transmission 454. For example, the base station 105 may parse the report transmission 454 (e.g., the report information 442 thereof) based on a report configuration indicated by the configuration transmission 450 and/or the report configuration information 444 to determine the sidelink information 406 and/or sidelink radio link failure information 408 of or indicated by the report information 442. The base station 105 may then generate remediation information based on the sidelink information 406, the sidelink radio link failure information 408 and/or the report information 442. To illustrate, the base station 105 may transmit a remediation indication 456 including a remediation action or the remediation information. The remediation indication 456 may be transmitted to another base station, the UE 115, or the second UE 403.

A device which receives the remediation indication 456 may then adjust a setting or configuration to reestablish a connection (e.g., reconnect), perform handover or reselection operations, improve an active connection, enable a relay connection, reduce interference, reduce failures, or a combination thereof, at the UE 115. For example, the UE 115 receives the remediation indication 456 and may adjust a dynamic grant, a configured grant, a slot format, a BWP, etc., to avoid errors and/or failures. As another example, the UE 115 may adjust a transmission power or beam parameter to avoid errors and/or failures. Additionally, or alternatively, other devices may adjust a configuration or setting to reduce errors and/or failures at the UE 115. For example, the second UE 403 may adjust one or more of the configurations or settings discussed above to reduce errors and/or failures at or experienced by the UE 115. Although the example of FIG. 4 is directed to sidelink radio link failure operations, in other implementations, the devices may additionally or alternatively report and remediate beam failures, handover failures, connection failures, reselection operations, handover operations, suspend/resume operations. The sidelink information may be reported with the sidelink failure report (e.g., in the same report or transmission) or in addition to the sidelink failure report (e.g., in another report or transmission).

Accordingly, the network (e.g., the base station 105, the UE 115, and the second UE 403) may be able to more efficiently and effectively recover from failures and enable operations in relay and remote UE operations. Reduce failures and improved failure recovery through enhanced sidelink information reporting may increase throughput and reduce latency, which may lead to better connections. Accordingly, the network performance and experience may be increased due to the increases in speed and reductions in failure.

Referring to FIG. 5, FIG. 5 is a timing diagram 500 illustrating a wireless communication system that supports enhanced sidelink information reporting according to one or more aspects. The example of FIG. 5 corresponds to an example of enhanced sidelink radio link failure information reporting for sidelink radio link failure reporting operations.

The example of FIG. 5 includes similar devices to the devices described in FIGS. 1, 2, and 4, such as a UE 115 (e.g., a first UE), a second UE 503 (e.g., second UE 403), and a network entity (e.g., base station 105). The devices of FIG. 5 may include one or more of the components as described in FIGS. 2 and 4. In FIG. 5, these devices may utilize antennas 252a-r, transmitter 410, receiver 412, encoder 413 and/or decoder 414, or may utilize antennas 234a-t, transmitter 434, receiver 436, encoder 437 and/or decoder 438 to communicate and receive transmissions. In some implementations, network entity may include or correspond to multiple TRPs of a single base station (e.g., base station 105), to multiple base stations, or any combination thereof.

At 510, the base station 105 and the UE 115 establish a Uu communication link (also referred to as Uu link or UL/DL link). For example, the UE 115 may perform RRC, RACH, and/or connection establishment operations to establish (or re-establish) an uplink and downlink communication link with a node of a network, such as base station 105. In some implementations, the communication link may be established as part of a handover operation or through another UE. As illustrated in the example of FIG. 5, the base station 105 and UE 115 may communicate higher layer signaling, such as RRC signaling (e.g., a RRC transmission or message) or control layer signaling, to establish the connection and link.

At 515, the UE 115 and the second UE 503 establish a PC5 communication link (also referred to as PC5 link or SL link). For example, the UE 115 may perform RRC, RACH, and/or connection establishment operations to establish (or re-establish) direct, device-to-device communication link with another UE that is connected to the network, such as base station 105 or another node of the network, such as a second base station. In some implementations, the communication link may be established as part of a handover operation or through another UE. As illustrated in the example of FIG. 5, the UE 115 and second UE 503 may communicate higher layer signaling, such as RRC signaling (e.g., a RRC transmission or message) or control layer signaling, to establish the connection. Although one PC5 link is illustrated in the example of FIG. 5, the UE 115 and/or the second UE 503 may have multiple PC5 links at one time.

After establishing the Uu communication link, the base station 105 and the UE 115 may communicate or exchange transmissions at 520. For example, the UE 115 may receive downlink transmissions from the base station 105 and/or transmit uplink transmissions to the base station 105, such as to communicate data. Although such operations are indicated after establishment of the PC5 link, the transmissions may occur prior to establishment of the PC5 link at 515, or both prior to and after the establishment of the PC5 link at 515.

After establishing the PC5 communication link, the UE 115 and the second UE 503 may communicate or exchange transmissions at 525. For example, the UE 115 may receive sidelink transmissions from the second UE 503 and/or transmit sidelink transmissions to the second UE 503, such as to communicate data. The sidelink transmissions may be communicated in resources of one or more modes, such as mode 1 and/or mode 2. Mode 1 resources may include resources that are directly scheduled by the network, and mode 2 resources may include resources that are allocated by the network and/or scheduled by the UEs themselves (e.g., the UE 115, the second UE 503, or both). Although the establishment of the PC5 link and the PC5 transmissions are illustrated as occurring after the establishment of the Uu link at 510 and Uu transmissions at 520 respectively, in other implementations the establishment of the PC5 link at 515 and/or the PC5 transmissions at 525 may occur prior to the establishment of the Uu link and/or Uu transmissions.

At 530, the UE 115 may determine a sidelink radio link failure for a sidelink communication link. For example, the UE 115 may determine a sidelink radio link failure for the PC5 communication link with the second UE 503. To illustrate, the UE 115 may determine the sidelink radio link failure based on satisfaction of a timer condition (e.g., expiration of T400), satisfaction of a DTX condition, satisfaction of an RLC transmission count condition, satisfaction of an integrity check condition, or a combination thereof based on the sidelink transmissions (including any failed transmissions) with the second UE 503.

As illustrative, non-limiting examples, a sidelink radio link failure may be determined or declared responsive to expiration of a timer (e.g., timer T400 or another RRC related sidelink timer), an indication from a sidelink MAC entity that a threshold count (e.g., a maximum number) of consecutive HARQ DTX for a specific destination has been reached (e.g., modify sl-maxNumConsecutiveDTX), an indication from a sidelink RLC entity that the maximum number of retransmissions for a specific destination has been reached (e.g., modify sl-MaxRetxThreshold-r16), an integrity check failure from a Sidelink PDCP entity concerning sidelink signal radio bearers (SL-SRB), such as SL-SRB2 or SL-SRB3, or a combination thereof.

In connection with operation of the PC5 communication and/or determination of the sidelink radio link failure, the UE 115 may determine or generate sidelink link information, such as sidelink radio link failure information. For example, the UE 115 may determine sidelink radio link failure information (e.g., sidelink radio link failure information 408) based on the sidelink information 406, position information, location information, or a combination thereof. As described with reference to FIG. 4, the sidelink link information (e.g., sidelink radio link failure information) may include enhanced information from information currently recorded in the art for SL operations and/or reported to other (e.g., network) devices for sidelink or Uu radio link failure. In the specific example of FIG. 5, sidelink radio link failure information which is included in the sidelink report further includes location information of the UE 115, such as GPS or GNSS computed position augmented with Bluetooth or WiFi information and/or sensor information, and radio link failure cause information.

After generation of the sidelink link information, such as sidelink radio link failure information, the UE 115 may store such information in a current or new IE or variable. For example, the UE 115 may store the information in a current variable/field of a SidelinkUEInformationNR message or a new variable/field, such as Var-RLFReport. The new variable may include or correspond to a new field of the SidelinkUEInformationNR message or a new message, such as a new or enhanced SidelinkUEInformationNR message or a message separate from (e.g., subsequent to) the SidelinkUEInformationNR message.

At 535, the UE 115 transmits sidelink RLF report information to the base station 105. For example, the report manager 416 of the UE 115 may generate SL RLF report information based on the sidelink radio link failure information (e.g., 408) and include the SL RLF report information (e.g., 442, such as an enhanced SL RLF report) in a SL RLF report transmission, and the UE 115 may transmit the SL RLF report transmission (e.g., 456) to the base station 105 in an uplink transmission. In some implementations, the UE 115 transmits the SL RLF report (or the sidelink radio link failure information) to the base station 105 directly (e.g., pushes the sidelink radio link failure information to network) without an indication or request, as illustrated in the example of FIG. 5. In other implementations, the UE 115 may first transmit an indication (e.g., a scheduling request or other message) to the network indicating that the UE 115 has sidelink radio link failure information or a sidelink radio link failure report to send. The UE 115 may then receive a request message from the base station 105 which schedules the transmission of the sidelink radio link failure information and/or the sidelink radio link failure report.

Alternatively, the UE 115 may transmit the sidelink radio link failure information in a transmission which is separate from the sidelink radio link failure report. In such implementations, the UE 115 may transmit the sidelink radio link failure information prior to or after the transmission of the sidelink radio link failure report at 535. The UE 115 may refrain from including or may exclude the sidelink radio link failure information from the sidelink radio link failure report.

At 540, the base station 105 determines remediation information based on receiving the sidelink radio link failure information and/or sidelink radio link failure report transmission at 535. For example, the base station 105 may receive and parse the sidelink radio link failure report transmission to determine or identify sidelink radio link failure information thereof. The base station 105, such as the remediation manager 440 thereof, may identify one or more Uu parameters, PC5 parameters, or a combination thereof to modify or change. To illustrate, the base station 105 may modify UL/DL settings or operations, sidelink settings or operations, or a combination thereof to help the UE 115 and the second UE 403 reestablish the direct communication link. The base station 105 may generate remediation information indicative of such actions to reestablish the PC5 communication link.

At 545, the base station 105 may transmit remediation information to the UE 115. For example, the base station 105 may transmit remediation information indicating a particular configuration change for the UE 115. To illustrate, the base station 105 may transmit DCI, a MAC CE, or RRC signaling to indicate a configuration change for the UE 115. The change may include a configuration adjustment or setting modification, such as a higher layer configuration or parameter, and as described further with reference to FIG. 4. As illustrative, non-limiting examples, the change may include a change in slot settings (e.g., slot format), transmission timing (e.g., configured grant timing, dynamic grant timing, etc.), transmission power, beam information, or a combination thereof.

Additionally, or alternatively, at 550, the base station 105 may transmit remediation information to the second UE 503. For example, the base station 105 may transmit the remediation information or second remediation information to the second UE 503. To illustrate, the base station 105 may transmit the same remediation information to the second UE 503 as it did to the UE 115 or it may transmit different remediation information to the second UE 503. After receiving the remediation information, one or more of the UEs may modify its operation or a transmission or receive parameter to reestablish the PC5 communication link, at 555.

Optionally, the base station 105 may perform one or more additional operations. For example, the base station 105 may not transmit a remediation indication including remediation information and may instead adjust a configuration or setting of the base station 105. Alternatively, the base station 105 may transmit a remediation indication including remediation information to another base station, such as a base station of another cell or cell group. The other base station may then relay the remediation indication (or the remediation information thereof) or transmit a second remediation indication based on the received remediation indication. For example, the other base station may transmit the remediation indication to a UE of another cell group to reestablish the PC5 communication link, such as by reducing interference between the UE 115 and the second UE 503.

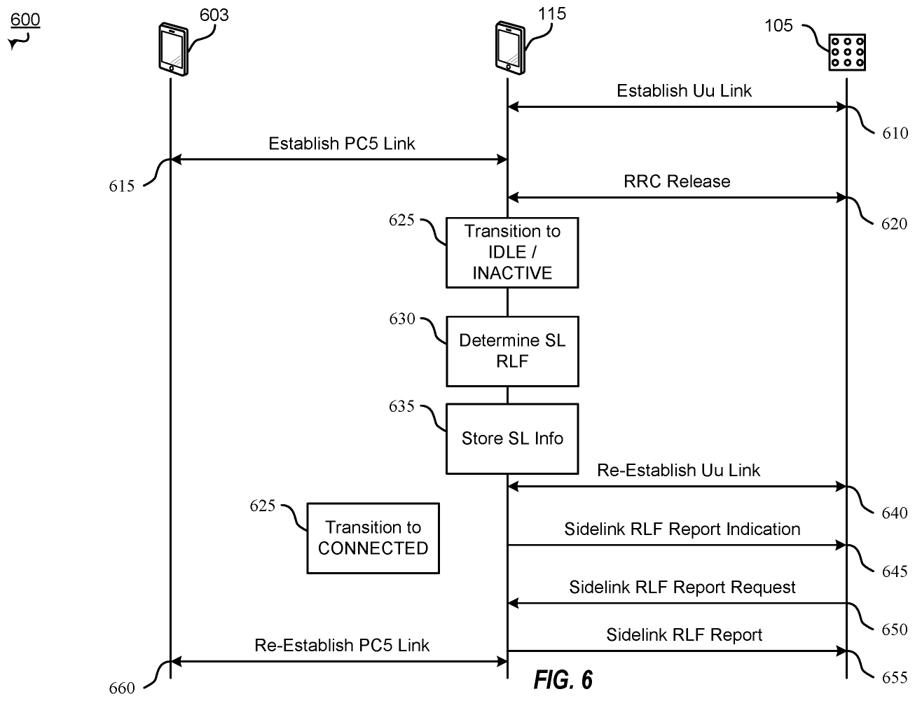

Although the example of FIG. 5 is described with reference to a sidelink radio link failure, where the sidelink information includes sidelink radio link failure information and the sidelink information is reported in a sidelink radio link failure report, in other implementations, the devices may report other types of sidelink information, report the sidelink information in other messages or reports, use other reporting schemes (e.g., push or pull), report the sidelink information in response to other types of failures and/or report the sidelink information in response to failures with the network, as described in the examples of FIGS. 6-11. Accordingly, in the example, of FIG. 5, devices of the network may be able to engage in enhanced sidelink information reporting in a sidelink radio link failure report in response to a sidelink failure when the UE has an active Uu link.

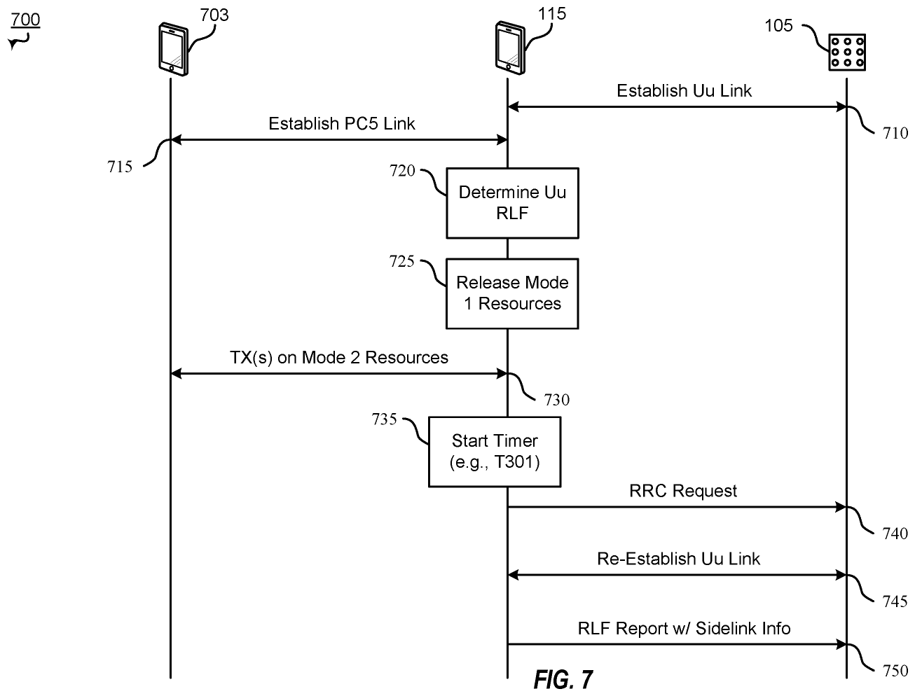

Referring to FIG. 6, FIG. 6 is a timing diagram 600 illustrating a wireless communication system that supports enhanced sidelink information reporting according to one or more aspects. The example of FIG. 6 corresponds to another example of enhanced sidelink radio link failure information reporting for sidelink radio link failure reporting operations. As compared to the example of FIG. 5, in the example of FIG. 6 the UE 115 does not have an active Uu link when a sidelink radio link failure is detected. Thus, the connection must be re-established to transmit the sidelink radio link failure information to the network, such as the base station 105. The sidelink radio link failure information may be transmitted in a new Sidelink RLF Report in Uu or in an enhanced existing RLF Report with sidelink RLF details. The sidelink RLF details may include the information described with reference to FIGS. 4 and/or 5 or with reference to any of FIGS. 7-11.

The example of FIG. 6 includes similar devices to the devices described in FIGS. 1, 2, and 4, such as a UE 115 (e.g., a first UE), a second UE 603 (e.g., second UE 403 or 503), and a network entity (e.g., base station 105). The devices of FIG. 6 may include one or more of the components as described in FIGS. 2 and 4. In FIG. 6, these devices may utilize antennas 252a-r, transmitter 410, receiver 412, encoder 413 and/or decoder 414, or may utilize antennas 234a-t, transmitter 434, receiver 436, encoder 437 and/or decoder 438 to communicate and receive transmissions. In some implementations, network entity may include or correspond to multiple TRPs of a single base station (e.g., base station 105), to multiple base stations, or any combination thereof.

At 610, the base station 105 and the UE 115 establish a Uu communication link as described with reference to 510 of FIG. 5. At 615, the UE 115 and the second UE 503 establish a PC5 communication link as described with reference to 515 of FIG. 5. As described with reference to FIG. 5 at 520 and 525, the UE 115, the second UE 603, and the base station 105 may communicate with each other over the communication links by transmitting and/or receiving transmissions.

After establishing the Uu communication links and operation therein, the Uu communication link between the UE 115 and the base station 105 may stop or cease to exist. For example, the communication link may fail, be suspended, go inactive, etc., for any reason or combination of reasons.

In the example illustrated in FIG. 6, the base station 105 may transmit a connection release message to the UE 115 at 620. For example, the base station 105 may transmit a RRC or other higher layer message to the UE 115 to release or suspend the Uu connection. To illustrate, the base station 105 may transmit a RRCRelease message (with or without a suspend indication) to the UE 115 to release or suspend the Uu connection.

At 625, the UE 115 may transition to an RRC IDLE or INACTIVE mode. For example, the UE 115 may receive the connection release message and determine to switch to from a RRC CONNECTED mode to a RRC IDLE or INACTIVE mode. To illustrate, responsive to and/or or based on receipt of a RRC release message the UE switches to from a RRC CONNECTED mode to a RRC IDLE or INACTIVE mode.

After transition to the RRC IDLE or INACTIVE mode, the UE 115 may still be connected to the second UE 603. For example, the UE 115 and the second UE 603 may still have an active PC5 link and exchange transmissions over the PC5 link.

At 630, the UE 115 may determine a sidelink radio link failure for a sidelink communication link as described with reference to 530 of FIG. 5. For example, the UE 115 may determine a sidelink radio link failure for the PC5 communication link with the second UE 603. As compared to the example of FIG. 5, when UE 115 experiences and/or determines the sidelink radio link failure with the second UE 603 in FIG. 6, the UE 115 is no longer connected to the base station 105. For example, the UE 115 does not have an active Uu link with the base station 105 (e.g., it may be inactive or suspended) and/or the UE 115 may not be in an RRC CONNECTED mode (e.g., may be in a IDLE or INACTIVE mode) when the UE 115 determines the sidelink radio link failure with the second UE 603.

As described with reference to FIG. 5, in connection with operation of the PC5 communication link and/or determination of the sidelink radio link failure, the UE 115 may determine or generate sidelink link information, such as sidelink radio link failure information about the detected sidelink RLF and optionally about continued sidelink operations (referred to as sidelink operations or activity information). As described with reference to FIG. 4, the sidelink link information (e.g., sidelink radio link failure information) may include enhanced information from information currently recorded in the art for SL operations and/or reported to other (e.g., network) devices for sidelink or Uu radio link failure.

In the example of FIG. 6, the enhanced sidelink information may include or correspond to, and the sidelink RLF Report in Uu may include, information regarding one or more of: a sidelink destination ID (or TX/RX UE ID), a sidelink RLF cause, a time since Sidelink RLF, available measurement results, location information (e.g., GNSS or sensor based), a speed of the UE, a direction of the UE, a RAT indication (LTE PC5 or NR PC5), a Mode type (mode-1 or mode-2), an indication whether SL Tx exception pool was used during sidelink RLF, the exception pool resources used, an indication whether CG-Type1 resources were released due to reestablishment, a Zone ID or TX-RX distance, a time stamp, PC5 frequency details (SL PointA, SL SSB frequency, SL SCS, valueN, or sync priority.

After generation of the sidelink link information, such as sidelink radio link failure information, the UE 115 may store such information in a current or new IE or variable at 635. For example, the UE 115 may store the information in a current variable/field (e.g., Var-RLFReport) of a SidelinkUEInformationNR message or a new variable/field. The new variable may include or correspond to a new field of the SidelinkUEInformationNR message or a new message, such as a new or enhanced SidelinkUEInformationNR message or a message subsequent to SidelinkUEInformationNR message.

At 640, the UE 115 may establish (e.g. re-establish) the Uu link with the base station 105 after transition to the IDLE or INACTIVE mode at 620. For example, the UE 115 may re-establish the Uu link with the base station 105 based on performing connection reestablishment procedures, such as CE or RACH procedures. Alternatively, the UE 115 may resume the link with the base station 105 from a suspended state. To illustrate, the UE 115 and the base station 105 may exchange one or more higher layer (e.g., RRC) messages to restore the link or start a new link. The UE 115 may enter or transition to a RRC CONNECTED mode with the base station 105 upon establishing (e.g. re-establishing) the Uu link with the base station 105.

At 645, the UE 115 transmits a sidelink RLF report indication to the base station 105. For example, the report manager 416 of the UE 115 may generate a SL RLF report indication based on the sidelink radio link failure information or SL RLF report information (e.g., SL RLF report or an enhanced SL RLF report), and the UE 115 may transmit the SL RLF report indication to the base station 105 in an uplink transmission. The report indication may indicate that the UE 115 has a RLF report to send, a SL RLF report to send, sidelink information (e.g., sidelink radio link failure information) to send, or a combination thereof.

At 650, the base station 105 transmits a sidelink RLF report request to the UE 115. For example, the base station 105 may receive the sidelink RLF report indication and the base station 105 (e.g., the report manager 439 thereof) may generate a sidelink RLF report request based on and/or responsive to receiving sidelink RLF report indication. The sidelink RLF report request may include an indication to send a sidelink RLF report (e.g., sidelink RLF report information), the sidelink radio link information, or both. Additionally, or alternatively, the sidelink RLF report request may indicate the transmission resources in which the UE 115 is to transmit the sidelink RLF report (e.g., sidelink RLF report information), the sidelink radio link information, or both.

At 655, the UE 115 transmits sidelink RLF report information to the base station 105. For example, the UE 115 may receive the sidelink RLF report request and the UE 115 (e.g., the report manager 416 thereof) may transmit a SL RLF report transmission to the base station 105 in an uplink transmission. To illustrate, the UE 115 (e.g., the report manager 416 thereof) may generate SL RLF report information based on the sidelink radio link failure information and include the SL RLF report information (e.g., an enhanced SL RLF report) in a SL RLF report transmission, and the UE 115 may transmit the SL RLF report transmission to the base station 105 in an uplink transmission.

In other implementations, the UE 115 transmits the SL RLF report (or the sidelink radio link failure information) to the base station 105 directly (e.g., pushes the sidelink radio link failure information to network) without an indication or request, as illustrated in the example of FIG. 5.

Additionally, or alternatively, the UE 115 may transmit the sidelink radio link failure information in a transmission which is separate from the sidelink radio link failure report. In such implementations, the UE 115 may transmit the sidelink radio link failure information prior to or after the transmission of the sidelink radio link failure report at 655. The UE 115 may refrain from including or exclude the sidelink radio link failure information from the sidelink radio link failure report.

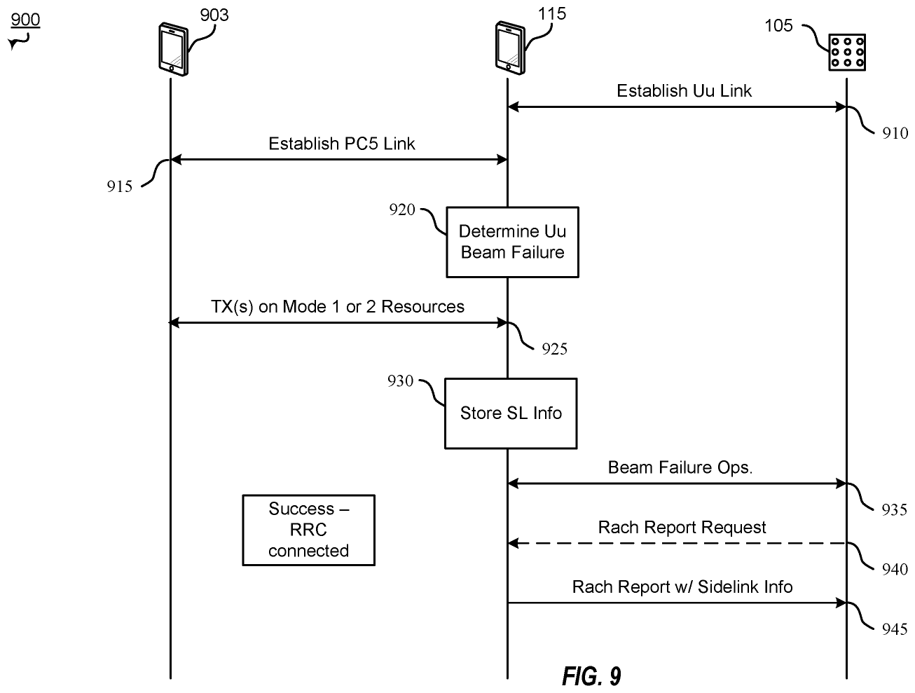

When the sidelink information (e.g., sidelink radio link failure information) is sent separately from a RLF or SL RLF report, the sidelink information (e.g., sidelink radio link failure information) may be sent in another report in some implementations. As illustrative, non-limiting examples, the sidelink information (e.g., sidelink radio link failure information) may be sent in a Random Access Channel (RACH) report, a connection establishment failure (CEF) report, a mobility history report (MHR), or a successful handover report (SHR). Examples of sending the sidelink information (e.g., sidelink radio link failure information) in other reports are described further with reference to FIGS. 9-11.

At 660, the UE 115 may optionally establish a PC5 link after transmission of the SL RLF report (and/or sidelink radio failure information). For example, the UE 115 may re-establish the PC5 link with the second UE 603 as illustrated in FIG. 6. Alternatively, the UE 115 may establish a PC5 link (e.g., second PC5 link) with another UE (e.g., a third UE, such as third UE 803b) or not establish another PC5 link.

In some implementations, the devices may perform one or more remediation operations, such as the remediation operations 540-550 as described with reference to FIG. 5 prior to establishing the PC5 link. The remediation operations may enable or help re-establish the PC5 link between the UE 115 and the second UE 603.

Although the example of FIG. 6 is described with reference to a sidelink radio link failure without an active Uu link, where the sidelink information includes sidelink radio link failure information and the sidelink information is reported in a sidelink radio link failure report, in other implementations, the devices may report other types of sidelink information, report the sidelink information in other messages or reports, use other reporting schemes (e.g., push or pull), report the sidelink information in response to other types of failures and/or report the sidelink information in response to failures with the network, as described in the examples of FIGS. 6-11. Accordingly, in the example, of FIG. 6, devices of the network may be able to engage in enhanced sidelink information reporting in a sidelink radio link failure report in response to a sidelink failure when the UE does not have an active Uu link.

Referring to FIG. 7, FIG. 7 is a timing diagram 700 illustrating a wireless communication system that supports enhanced sidelink information reporting according to one or more aspects. The example of FIG. 7 corresponds to an example of enhanced sidelink radio link failure information reporting for uplink/downlink radio link failure reporting operations. As compared to the examples of FIGS. 5 and 6, the example of FIG. 7 is directed to a radio link failure between a UE and a base station, and transmitting sidelink related information (e.g., sidelink operations or activity information) to the base station in a Uu RLF report. This enables the UE to provide details on the sidelink connection during a Uu RLF as assistance to network (e.g., NG-RAN) on whether a sidelink connection was active during Uu RLF and optionally the operations or resources used. A RLF report may be enhanced with an indication that sidelink was active during Uu RLF and if Mode-2 exception pool resources were used or a new Uu RLF report may be generated to include this information.

The example of FIG. 7 includes similar devices to the devices described in FIGS. 1, 2, and 4, such as a UE 115 (e.g., a first UE), a second UE 703 (e.g., second UE 403, 503, or 603), and a network entity (e.g., base station 105). The devices of FIG. 7 may include one or more of the components as described in FIGS. 2 and 4. In FIG. 7, these devices may utilize antennas 252a-r, transmitter 410, receiver 412, encoder 413 and/or decoder 414, or may utilize antennas 234a-t, transmitter 434, receiver 436, encoder 437 and/or decoder 438 to communicate and receive transmissions. In some implementations, network entity may include or correspond to multiple TRPs of a single base station (e.g., base station 105), to multiple base stations, or any combination thereof.

At 710, the base station 105 and the UE 115 establish a Uu communication link as described with reference to 510 of FIG. 5. At 715, the UE 115 and the second UE 703 establish a PC5 communication link as described with reference to 515 of FIG. 5. As described with reference to FIG. 5 at 520 and 525, the UE 115, the second UE 703, and the base station 105 may communicate with each other over the communication links by transmitting and/or receiving transmissions.

At 720, the UE 115 may determine a Uu radio link failure for a downlink/uplink communication link. For example, the UE 115 may determine a radio link failure for the Uu communication link with the base station 105. To illustrate, the UE 115 may determine the radio link failure based on one or more conditions based on the downlink/uplink transmissions (including any failed transmissions) with the base station 105. The one or more conditions may include conditions known in the art, such as repeated or persistent beam failure, failure(s) on multiple beams, lack of candidate beams, satisfaction of a timer condition, indication from an RLC entity, satisfaction of an error condition, failed transmissions, satisfaction of a channel condition, satisfaction of a channel measurement, etc.

At 725, the UE 115 optionally releases mode-1 resources. For example, the UE 115 may release mode 1 resources (e.g., a mode one resource pool) or base station configured resources for sidelink/PC5 operations based on and/or responsive to determining the Uu radio link failure with the base station 105 at 720. To illustrate, the UE 115 may determine that mode-1 pool resources associated with or configured by the base station 105 (e.g., sent in a configured grant or SL type 1 configured grant) should be released based on the Uu radio link failure and optionally one or more configuration settings. In some such implementations, the resources may be released based on one or more conditions with respect to the radio link failure (e.g., such as RLF type and/or cause), one or more conditions with respect to the configuration settings (e.g., automatic release setting condition).

At 730, the UE 115 optionally operates on mode-2 resources of the PC5 link. For example, the UE 115 may use mode-2 exception pool resources to transmit data to the second UE 703 and/or to receive data from the second UE 703. To illustrate, the UE 115 may determine that mode-2 exception pool resources are available based on a SIB message associated with the base station 105 and determine to use the mode-2 exception pool resources based on one or more configuration settings. Thus, the UE 115 and the second UE 703 may operate on the sidelink link after radio link failure on the Uu link between the UE 115 and the base station 105. Alternatively, in other implementations, the UE 115 may determine to release mode 2 resources along with the mode 1 resources at 725 or may determine to release mode 2 resources based one or more other conditions, such as on one or more conditions with respect to the radio link failure (e.g., such as RLF type and/or cause), one or more conditions with respect to the configuration settings (e.g., automatic release setting condition).

At 735, the UE 115 may start a timer after determining the radio link failure at 720. For example, the UE 115 may start a radio link failure timer responsive to and/or based on detection of the radio link failure at 720. To illustrate, the UE 115 may start a timer T311 responsive to and/or based on detection of the radio link failure at 720. In other implementations, the UE 115 may start the timer (or another timer) responsive to another event, such as after starting reconnection procedures or based on a time associated with a last failed transmission.

In connection with operation of the PC5 communication link and/or determination of the Uu radio link failure, the UE 115 may determine or generate sidelink link information, such as sidelink operations or activity information. For example, the UE 115 may determine sidelink operations or activity information (e.g., sidelink information 406) based on whether the sidelink link with the second UE 703 was active and whether mode-2 resources were used. As described with reference to FIG. 4, the sidelink link information (e.g., sidelink operations or activity information and optionally any sidelink related failure information) may include enhanced information from information currently recorded in the art for SL operations and/or reported to other (e.g., network) devices for Uu radio link failure. After generation of the sidelink link information, such as sidelink radio operations or activity information, the UE 115 may store such information in a current or new IE or variable, as described with reference to FIG. 5.

After radio link failure and possible loss of connection/Uu link, the UE 115 may perform reconnection procedures, such as connection re-establishment procedures, such one or more of the connection establishment procedures of FIG. 3. As illustrated in the example of FIG. 7, at 740, the UE 115 transmits a connection establishment (re-establishment) request. For example, the UE 115 may transmit a RRC re-establishment request to the base station 105. To illustrate, the UE 115 may indicate to the base station 105 it intends to re-establish the Uu link and may send connection establishment information or request initiation of connection establishment procedures.

At 745, the UE 115 may establish (e.g. re-establish) the Uu link with the base station 105 after transmission of the connection request at 740. For example, the UE 115 may re-establish the Uu link with the base station 105 based on performing connection reestablishment procedures, such as CE or RACH procedures, which include the transmission of the connection request or which are initiated by the transmission of the connection request. To illustrate, the UE 115 and the base station 105 may exchange one or more higher layer (e.g., RRC) messages to restore the link or start a new link. The UE 115 may enter or transition to a RRC CONNECTED mode with the base station 105 after performance of the connection establishment procedures and upon establishing (e.g. re-establishing) the Uu link with the base station 105. Alternatively, the UE 115 may not experience a radio link failure and may resume a suspended link with the base station 105 based on transmission of a RRC resume request.

At 750, the UE 115 transmits sidelink information to the base station 105. For example, the UE 115 (e.g., the report manager 416 thereof) may transmit a Uu RLF report transmission to the base station 105 in an uplink transmission upon reconnection to the base station 105 (e.g., some time after reconnection at 745). To illustrate, the UE 115 (e.g., the report manager 416 thereof) may generate Uu RLF report information based on the sidelink operations or activity information and include the Uu RLF report information (e.g., an enhanced SL RLF report) in a Uu RLF report transmission, and the UE 115 may transmit the Uu RLF report transmission to the base station 105 in an uplink transmission.

In some implementations, the UE 115 transmits the Uu RLF report (or the sidelink operations or activity information) to the base station 105 directly (e.g., pushes the sidelink operations or activity information to network) without an indication or request, as illustrated in the example of FIG. 5. In other implementations, such as illustrated in the pull reporting scheme of FIG. 6, the network may pull the report from the UE. For example and as described with reference to FIG. 6, the UE 115 may first transmit an indication (e.g., a scheduling request or other message) to the network indicating that the UE 115 has sidelink operations or activity information or a Uu radio link failure report to send. The UE 115 may then receive a request message from the base station 105 which schedules the transmission of the sidelink operations or activity information and/or the Uu radio link failure report. In some such implementations, the sidelink information transmitted (e.g., the sidelink information in the Uu RLF report) include sidelink radio link failure information for one or more SL RLFs for and/or detected by the UE 115 or for one or more SL RLFs for any remote UEs connected via relay to the base station 105 by the UE 115.

Additionally, or alternatively, the UE 115 may transmit the sidelink information in a transmission which is separate from the Uu radio link failure report. In such implementations, the UE 115 may transmit the sidelink information prior to or after the transmission of the Uu radio link failure report at 750. The UE 115 may refrain from including or exclude the sidelink information from the Uu radio link failure report.

When the sidelink information (e.g., sidelink operations or activity information) is sent separately from a RLF or SL RLF report, the sidelink information (e.g., sidelink operations or activity information) may be sent in another report in some implementations. As illustrative, non-limiting examples, the sidelink information (e.g., sidelink radio link failure information) may be sent in a Random Access Channel (RACH) report, a connection establishment failure (CEF) report, a mobility history report (MHR), or a successful handover report (SHR). Examples of sending the sidelink information (e.g., sidelink radio link failure information) in other reports are described further with reference to FIGS. 9-11.

After 750, the UE 115 may optionally re-establish the mode 1 resources for the PC5 link or configure new mode 1 resources based on information from the base station 105. The UE 115 and the second 703 may optionally engage in PC5 communications using mode 1 resources, mode 2 resources, or both. For example, the UE 115 may receive a configured grant from the base station 105 indicating mode 1 resources.

Although not shown in the examples of FIGS. 5-7, the second UE 503, 603, or 703 may also experience a radio link failure with the base station 105 at any time during the operations of FIGS. 5-7.

Although the example of FIG. 7 is described with reference to a Uu radio link failure, where the sidelink information includes sidelink operations information and the sidelink information is reported in a Uu radio link failure report, in other implementations, the devices may report other types of sidelink information, report the sidelink information in other messages or reports, use other reporting schemes (e.g., push or pull), report the sidelink information in response to other types of failures and/or report the sidelink information in response to failures with the network, as described in the examples of FIGS. 5, 6, and 8-11. Accordingly, in the example, of FIG. 7, devices of the network may be able to engage in enhanced sidelink information reporting in a Uu radio link failure report in response to a Uu link failure.

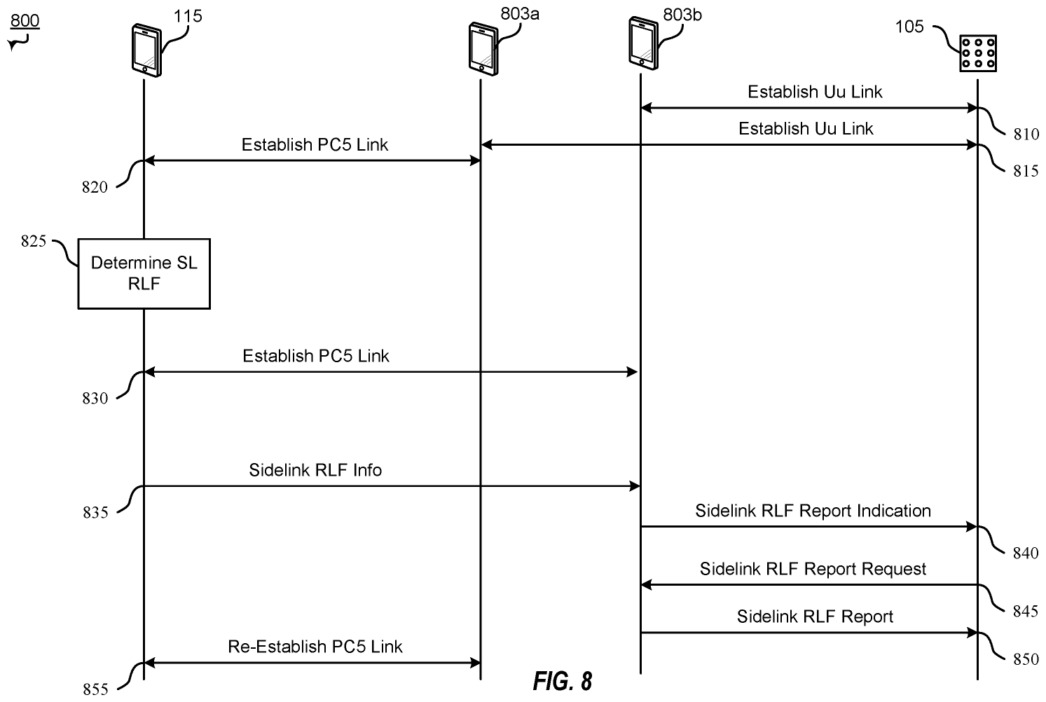

Referring to FIG. 8, FIG. 8 is a timing diagram 800 illustrating a wireless communication system that supports enhanced sidelink information reporting according to one or more aspects. The example of FIG. 8 corresponds to an example of enhanced sidelink radio link failure information reporting for uplink/downlink radio link failure reporting operations. As compared to the examples of FIGS. 5-7, the example of FIG. 8 is directed to remote UE that experiences a sidelink radio link failure for its corresponding relay UE which connects the remote UE to a particular base station and transmitting sidelink related information (e.g., sidelink radio link failure information) to the base station in a relayed sidelink RLF report.

In the example of FIG. 8, a sidelink RLF is detected by a remote UE and relay reselection may be triggered responsive to detection. Currently, there is no mechanism to report sidelink related relay failures. The aspects of FIG. 8 include a relay related PC5 RLF report to indicate sidelink relay related RLF details. The relay related PC5 RLF report can include details such as old relay ID, new relay ID, reason for relay reselection, etc. and be reported in a push or pull manner.

The example of FIG. 8 includes similar devices to the devices described in FIGS. 1, 2, and 4, such as a UE 115 (e.g., a first UE or remote UE), a second UE 803a (e.g., a second UE 403, 503, 603, 703, 803a, 903, or 1003a, or a first relay UE), a third UE 803b (e.g., a third UE 803b or 1003b, or second relay UE), and a network entity (e.g., base station 105). The devices of FIG. 8 may include one or more of the components as described in FIGS. 2 and 4. In FIG. 8, these devices may utilize antennas 252a-r, transmitter 410, receiver 412, encoder 413 and/or decoder 414, or may utilize antennas 234a-t, transmitter 434, receiver 436, encoder 437 and/or decoder 438 to communicate and receive transmissions. In some implementations, network entity may include or correspond to multiple TRPs of a single base station (e.g., base station 105), to multiple base stations, or any combination thereof.

At 810, the base station 105 and the third UE 803b establish a Uu communication link as described with reference to 510 of FIG. 5. At 815, the base station 105 and the second UE 803a establish a Uu communication link as described with reference to 510 of FIG. 5. At 820, the UE 115 and the second UE 803a establish a PC5 communication link (e.g., first PC5 communication link) as described with reference to 515 of FIG. 5. As described with reference to FIG. 5 at 520 and 525, the UE 115, the second UE 803a, the third UE 803b, and the base station 105 may communicate with each other over the communication links by transmitting and/or receiving transmissions. For example, the PC5 link between the UE 115 and the second UE 803a may enable the UE 115 to connect or communicate with the base station 105, even if the UE 115 is considered a remote UE to the base station 105 and is located out of range of the base station 105, such as outside of a coverage or cell area. The PC5 link may enable relay communications, such as communications from the base station 105 or the UE 115 that are relayed to one another via the second UE 803a. For example, a communication may be transmitted by sidelink from the UE 115 to the second UE 803a and then relayed to the base station 105 via uplink.

At 825, the UE 115 may determine a sidelink radio link failure for a sidelink communication link. For example, the UE 115 may determine a sidelink radio link failure for the PC5 communication link with the second UE 803a. In the example of FIG. 8, the UE 115 is a remote UE which does not have its own direct link to the base station 105. Accordingly, the sidelink radio link failure may cause or lead to the loss of the sidelink communication link with the second UE 115 and the loss of the Uu or relay link with the base station 105 (via the second UE 803a). Examples of determinations for SL RLF are described further with reference to FIG. 5.

In connection with operation of the PC5 communication link and/or determination of the sidelink radio link failure, the UE 115 may determine or generate sidelink link information, such as sidelink radio link failure information, as described with reference to FIGS. 4-7. As described with reference to FIG. 4, the sidelink link information (e.g., sidelink radio link failure information) may include enhanced information from information currently recorded in the art for SL operations and/or reported to other (e.g., network) devices for sidelink relay radio link failure.

In the example, of FIG. 8, the sidelink radio link failure information may include relay related information, such as relay related sidelink radio link failure information. For example, the sidelink radio link failure information may include or correspond to relay ID information, reselection reasons/cause information, or a combination thereof. The relay ID information may include or correspond to a UE ID for an old relay, a UE ID for a new or active relay, or a combination thereof. The reselection reasons/cause information may indicate a reason for the relay reselection. The reason for the relay selection may include all of the previously described reasons for SL RLF failure, and additional relay related options such as relay handoff, relay selection or reselection condition satisfaction, etc. After generation of the sidelink link information, such as sidelink or relay radio link failure information, the UE 115 may store such information in a current or new IE or variable, as described with reference to FIG. 5.

At 830, the UE 115 and the third UE 803b establish a PC5 communication link, such as similar to establishing the PC5 communication link at 820. For example, the UE 115 may perform RACH and/or connection establishment operations to establish (or re-establish) direct, device-to-device communication link with another UE, such as third UE 803b, that is connected to the network, such as base station 105 or another node of the network (e.g., a second base station). In some implementations, the communication link may be established as part of a handover operation or through another UE (e.g., from the second UE 803a). As illustrated in the example of FIG. 8, the UE 115 and third UE 803b may communicate higher layer signaling, such as RRC signaling (e.g., a RRC transmission or message) or control transmissions, to establish the connection. The UEs may have additional PC5 links with each other or with other devices (not shown).

After establishing the PC5 communication link, the UE 115 and the third UE 803b may communicate or exchange transmissions. For example, the UE 115 may receive sidelink transmissions from the third UE 803b and/or transmit sidelink transmissions to the third UE 803b, such as to communicate data. The sidelink transmissions may be communicated in resources of one or more modes, such as mode 1 and/or mode 2. Mode 1 resources may include resources that are directly scheduled by the network and mode 2 resources may include resources that are allocated by the network and/or scheduled by the UEs themselves (e.g., the UE 115, the third UE 803b, or both). Although the establishment of the second PC5 link is illustrated as occurring after the establishment of the Uu links at 810, 815 and PC5 link at 820, in other implementations the establishment of the PC5 link at 830 and may occur prior to the establishment of the Uu links and/or first PC5 link.

After determination of the sidelink radio link failure and establishment of the (second) PC5 link between the UE 115 and the third UE 803b, the UE 115 transmits sidelink radio link failure information (e.g., the relay related sidelink information or sidelink radio link failure information) to the base station 105 via the third UE 803b. As illustrated in the example of FIG. 8, the UE 115 transmits sidelink RLF report information to the third UE 803b at 835. For example, the UE 115 (e.g., the report manager 416 thereof) may transmit a SL RLF report transmission to the third UE 803b in a sidelink transmission. To illustrate, the UE 115 (e.g., the report manager 416 thereof) may generate the SL RLF report information based on the sidelink radio link failure information and include the SL RLF report information (e.g., an enhanced SL RLF report or relay report) in a SL RLF report transmission, and the UE 115 may transmit the SL RLF report transmission to the third UE 803b in a sidelink transmission.

In some implementations, the UE 115 transmits the SL RLF report (or the sidelink radio link failure information) to third UE 803b directly (e.g., pushes the sidelink radio link failure information to the third UE 803b) without an indication or request, similar to the examples of FIGS. 5 and 7. In other implementations, such as illustrated in the pull reporting scheme of FIG. 6, the third UE 803b may pull the report from the UE 115. For example and as described with reference to FIG. 6, the UE 115 may first transmit an indication (e.g., a scheduling request or other message) to the third UE 803b indicating that the UE 115 has sidelink radio link failure information or a sidelink radio link failure report to send. The UE 115 may then receive a request message from the third UE 803b which schedules the transmission of the sidelink radio link failure information and/or the sidelink radio link failure report.

Additionally, or alternatively, the UE 115 may transmit the sidelink radio link failure information in a transmission which is separate from the sidelink radio link failure report. In such implementations, the UE 115 may transmit the sidelink radio link failure information prior to or after the transmission of the sidelink radio link failure report at 835. The UE 115 may refrain from including or exclude the sidelink radio link failure information from the sidelink radio link failure report.

When the sidelink information (e.g., sidelink radio link failure information) is sent separately from a RLF or SL RLF report to the third UE 803b, the sidelink information (e.g., relay related sidelink radio link failure information) may be sent in another report in some implementations. As illustrative, non-limiting examples, the sidelink information (e.g., sidelink radio link failure information) may be sent in a Random Access Channel (RACH) report, a connection establishment failure (CEF) report, a mobility history report (MHR), or a successful handover report (SHR). Examples of sending the sidelink information (e.g., sidelink radio link failure information) in other reports are described further with reference to FIGS. 9-11.

At 840, the third UE 803b transmits a sidelink RLF report indication to the base station 105. For example, the report manager 416 of the third UE 803b may generate a SL RLF report indication based on the sidelink radio link failure information or SL RLF report information (e.g., SL RLF report or an enhanced SL RLF report), and the third UE 803b may transmit the SL RLF report indication to the base station 105 in an uplink transmission. The report indication may indicate that the third UE 803b has a RLF report (e.g., relay RLF report) to send, a SL RLF report (e.g., relay SL RLF report) for the UE 115 to send, sidelink information (e.g., relay related sidelink radio link failure information) to send, or a combination thereof.

At 845, the base station 105 transmits a sidelink RLF report request to the third UE 803b. For example, the base station 105 may receive the sidelink RLF report indication, and the base station 105 (e.g., the report manager 439 thereof) may generate a sidelink RLF report request based on and/or responsive to receiving sidelink RLF report indication. The base station 105 may then send the sidelink RLF report indication to the third UE 803b in a downlink transmission, such as a downlink control channel transmission. The sidelink RLF report request may include an indication to send a sidelink RLF report (e.g., sidelink RLF report information), the sidelink radio link information, or both. Additionally, or alternatively, the sidelink RLF report request may indicate the transmission resources in which the third UE 803b is to transmit the sidelink RLF report (e.g., sidelink RLF report information), the sidelink radio link information, or both.

At 850, the third UE 803b transmits sidelink RLF report information to the base station 105. For example, the third UE 803b may receive the sidelink RLF report request and the third UE 803b (e.g., the report manager 416 thereof) may transmit a SL RLF report transmission to the base station 105 in an uplink transmission. To illustrate, the third UE 803b (e.g., the report manager 416 thereof) may generate the SL RLF report information based on the sidelink radio link failure information and include the SL RLF report information (e.g., an enhanced SL RLF report) in a SL RLF report transmission, and the third UE 803b may transmit the SL RLF report transmission to the base station 105 in an uplink transmission.

In other implementations, the third UE 803b transmits the SL RLF report (or the sidelink radio link failure information) to the base station 105 directly (e.g., pushes the sidelink radio link failure information to network) without an indication or request, as illustrated in the examples of FIGS. 5 and 7.

Additionally, or alternatively, the third UE 803b may transmit the sidelink radio link failure information in a transmission which is separate from the sidelink radio link failure report. In such implementations, the third UE 803b may transmit the sidelink radio link failure information prior to or after the transmission of the sidelink radio link failure report at 850. The third UE 803b may refrain from including or exclude the sidelink radio link failure information from the sidelink radio link failure report.

When the sidelink information (e.g., relay related sidelink radio link failure information) is sent separately from a RLF or SL RLF report to the base station 105, the sidelink information (e.g., sidelink radio link failure information) may be sent in another report in some implementations. As illustrative, non-limiting examples, the sidelink information (e.g., sidelink radio link failure information) may be sent in a Random Access Channel (RACH) report, a connection establishment failure (CEF) report, a mobility history report (MHR), or a successful handover report (SHR). Examples of sending the sidelink information (e.g., sidelink radio link failure information) in other reports are described further with reference to FIGS. 9-11.

At 855, the UE 115 may optionally establish a PC5 link after transmission of the SL RLF report (and/or sidelink radio failure information). For example, the UE 115 may re-establish the PC5 link with the second UE 803a as illustrated in FIG. 6. Alternatively, the UE 115 may establish a PC5 link (e.g., third PC5 link) with another UE (not shown) or not establish another PC5 link.

In other implementations, the UE 115 may fail the relay connection or reselection with the third UE 803b. In some such implementations, the UE 115 may try to connect to the base station 105 directly or through another relay UE (not shown). After successful PC5 and indirect Uu connection or successful direct Uu connection, the UE 115 may transmit the sidelink radio link failure report or relay related sidelink information to the base station 105 directly or through a fourth UE (not shown).

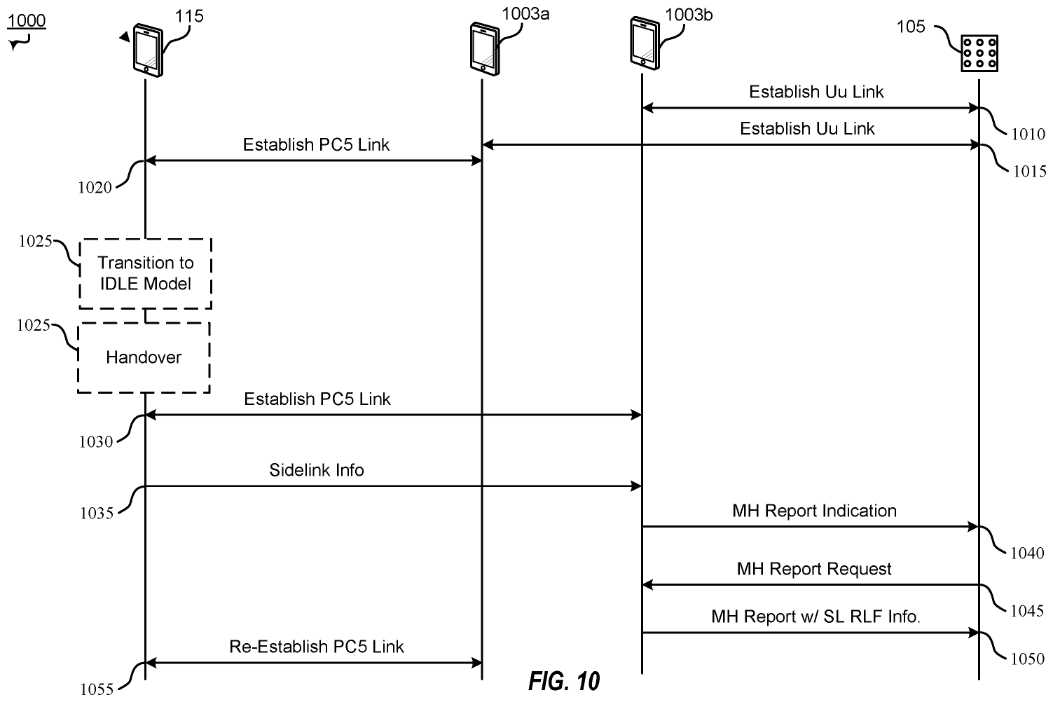

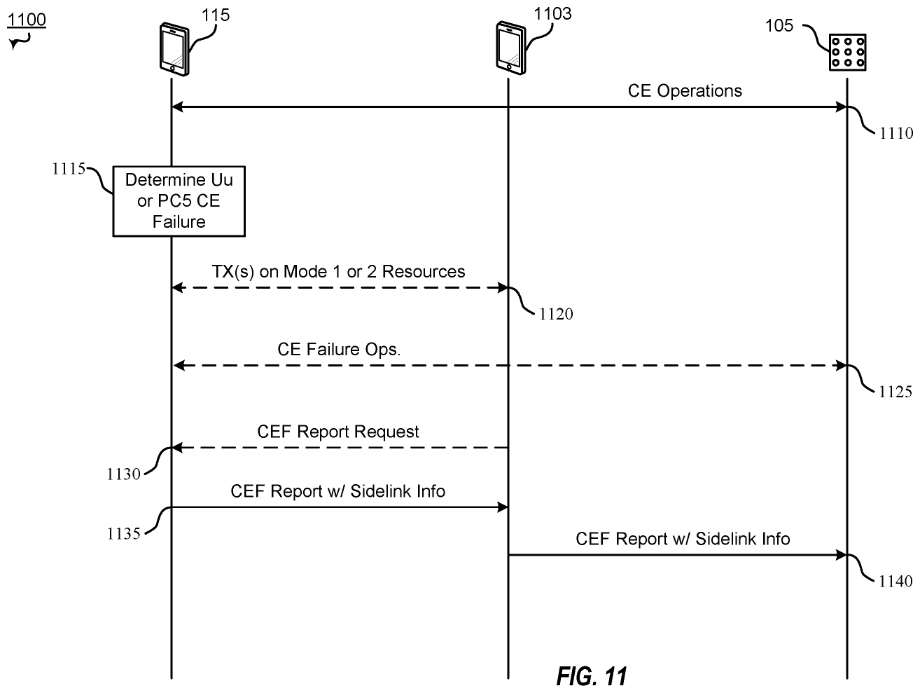

Although the example of FIG. 8 is described with reference to a sidelink radio link failure for a remote UE, in other implementations, the switch to the third UE 803b may occur due to a handover operation or due to cell reselection/RRC re-establishment for Uu or PC5 radio link failure for a relay UE (e.g., PC5 RLF detected in remote UE or Uu RLF notified by relay UE). The connection (e.g., RRC connection) may be established either via a gNB or via a relay UE. The examples of FIGS. 10 and 11 further describe relay scenarios and cell reselection scenarios.

In such scenarios, a remote UE may fail in multiple attempts (e.g., multiple interlaced attempts) via relay or via gNB directly before successfully re-established a Uu RRC. Currently, the attempts via relay or via gNB directly are not recorded or reported. Enhancements are therefore described herein for RLF reporting to capture and report L2 relay related information. The L2 relay related information may be recorded and/or reported when a source cell is relay or re-establishment triggered in case of L2 relay. The L2 relay related information may include information regarding failed Relay UE ID/relay's serving cell ID/TAC, attempted list of Relay UE ID/relay's serving cell ID/TAC, reestablished list of Relay UE ID/relay's serving cell ID/TAC, reconnected list of Relay UE ID/relay's serving cell ID/TAC, timing related information (e.g., timeConnFailure, timeSinceFailure, and/or timeUntilReconnection for the relays), a connection failure type (e.g., connectionFailureType for one or more of PC5-RLF, Uu-RLF, or handover failure), available serving relay and candidate relay PC5 measurements, or a combination thereof.

Although the example of FIG. 8 is described with reference to a sidelink radio link failure for a remote UE, where the sidelink information includes relay related sidelink radio link failure information and the sidelink information is reported in a sidelink radio link failure report, in other implementations, the devices may report other types of sidelink information, report the sidelink information in other messages or reports, use other reporting schemes (e.g., push or pull), report the sidelink information in response to other types of failures and/or report the sidelink information in response to failures with the network, as described in the examples of FIGS. 5-7 and 9-11. Accordingly, in the example, of FIG. 8, devices of the network may be able to engage in enhanced sidelink information reporting in a sidelink radio link failure report in response to a sidelink failure when the UE is a remote UE and out of coverage of the base station 105.

Referring to FIG. 9, FIG. 9 is a timing diagram 900 illustrating a wireless communication system that supports enhanced sidelink information reporting according to one or more aspects. The example of FIG. 9 corresponds to an example of enhanced sidelink operations information reporting in a RACH report for a Uu beam failure. As compared to the previous radio link failure examples of FIGS. 5-8, the example of FIG. 9 is directed to a beam failure between a UE and base station and transmitting sidelink related information (e.g., sidelink operations information and/or sidelink radio link failure information) to the base station in a Uu RACH report.

When a beam failure or physical layer problem occurs at the network, such as on a master cell group (MCG), a UE may continue using the configured sidelink grant Type 1 (e.g., mode 1 resources) until initiation of the RRC connection re-establishment procedure and configuration of mode 1 resources by a new sidelink configured grant. Currently, there is not mechanism to record or report sidelink related information, such as sidelink operations and/or failures during a beam failure or other physical layer error and recovery. Reporting this sidelink related information in a RACH report after recovery from the beam failure or physical layer problem, enables improved network operations in the future from the additional information. For example, the network, base station 105, may adjust sidelink resources for future use or future sidelink connections based on this information. Additionally, or alternatively, the network, base station 105, may adjust uplink and/or downlink resources for future use or uplink and/or downlink connections based on this information. Therefore, the network will have a clearer and more complete picture of what occurred between devices and on network resources during its temporary reduced connectivity with one or more connected UEs and can better configure or adjust the resources based on this additional information.

The example of FIG. 9 includes similar devices to the devices described in FIGS. 1, 2, and 4, such as a UE 115 (e.g., a first UE), a second UE 903 (e.g., second UE 403, 503, 603, or 703), and a network entity (e.g., base station 105). The devices of FIG. 9 may include one or more of the components as described in FIGS. 2 and 4. In FIG. 9, these devices may utilize antennas 252a-r, transmitter 410, receiver 412, encoder 413 and/or decoder 414, or may utilize antennas 234a-t, transmitter 434, receiver 436, encoder 437 and/or decoder 438 to communicate and receive transmissions. In some implementations, network entity may include or correspond to multiple TRPs of a single base station (e.g., base station 105), to multiple base stations, or any combination thereof.

At 910, the base station 105 and the UE 115 establish a Uu communication link as described with reference to 510 of FIG. 5. At 915, the UE 115 and the second UE 503 establish a PC5 communication link as described with reference to 515 of FIG. 5. As described with reference to FIG. 5 at 520 and 525, the UE 115, the second UE 903, and the base station 105 may communicate with each other over the communication links by transmitting and/or receiving transmissions.

At 920, the UE 115 may determine a Uu beam failure for a particular beam and/or TRP associated with the downlink/uplink communication link. For example, the UE 115 may determine a beam failure for one or more uplink and/or downlink beams used or configured for the Uu communication link with the base station 105. To illustrate, the UE 115 may determine the beam failure based on counting transmission failures, a timer condition, a channel condition (e.g., RSRP below a threshold), an error rate condition (e.g., block error rate (BLER)), another beam failure condition known in the art, or a combination thereof.

As illustrative, non-limiting example, a beam failure may be determined or declared responsive to determination of one or more beam or channel related parameters falling below a threshold. Alternatively, the beam failure may be determined or declared as known in the art.

At 925, the UE 115 optionally operates on mode-1 or mode-2 resources of the PC5 link. For example, the UE 115 may use mode-1 or mode-2 exception pool resources to transmit data to the second UE 703 and/or to receive data from the second UE 703. To illustrate, the UE 115 may determine that mode-1 pool resources are available based on a prior message on the failed or a message on a different beam (e.g., based on a received configured grant), that mode-2 exception pool resources are available based on a SIB message associated with the base station 105, or both, and determine to use the mode-1 pool resources, mode-2 exception pool resources, or a combination thereof based on one or more configuration settings. Thus, the UE 115 and the second UE 703 may operate on the sidelink link after beam failure on the Uu link between the UE 115 and the base station 105. As compared to the example in FIG. 7 where the UE 115, release mode-1 resources responsive to a radio link failure with the base station 105, in the example of FIG. 9, as the UE 115 has not declared radio link failure and still may be able to communicate with the base station 105 (or a TRP thereof of associated with the base station 105) using a different beam, the UE 115 may continue to use or attempt to use mode-1 resources. Alternatively, in other implementations, the UE 115 may optionally release mode-1 resources as described with reference to 725 of FIG. 7. The UE 115 may be configured to release mode-1 releases based on a condition or configuration that indicates to release mode-1 releases in the event of one or more beam failures and/or prior to radio link failure.

In connection with operation of the PC5 communication link at 925 and/or determination of the beam failure at 920, the UE 115 may determine or generate sidelink link information, such as sidelink operations and/or failure information. For example, the UE 115 may determine sidelink radio information (e.g., sidelink information 406 or sidelink radio link failure information 408) based on transmissions with the second UE 903. As described with reference to FIG. 4, the sidelink link information (e.g., sidelink operations or radio link failure information) may include enhanced information from information currently recorded in the art for SL operations and/or reported to other (e.g., network) devices in a RACH report for UU beam link failure.

The sidelink operations information may include or also be referred to as sidelink activity or resource information. The UE 115 may determine sidelink link activity information, sidelink resource information, or a combination thereof based on the operation of the PC5 communication link at 925. The sidelink link activity information may include or correspond to an indication (e.g., flag or bit) which indicates that one or more sidelink links (e.g., the sidelink link with the second UE 903) was active after the beam failure, prior to recovery, or both. To illustrate, a one bit flag may indicate that the sidelink link with the second UE 903 was active during RACH operations performed for beam failure recovery.

After generation of the sidelink link information, such as sidelink related information or sidelink operation information, the UE 115 may store such information in a current or new IE or variable at 930. For example, the UE 115 may store the information in a current variable/field of the SidelinkUEInformationNR message or a RACH Report message or a new variable/field. The variable may include or correspond to UE stores the sidelink information (and RACH information as described with reference to 935) in Var-RAReport.

Optionally, the UE 115 may start a timer after determining the beam failure at 920, as described with reference to 735 of FIG. 7. For example, the UE 115 may start a beam failure timer responsive to and/or based on detection of the beam failure at 920. To illustrate, the UE 115 may start a timer responsive to and/or based on detection of the beam failure at 920. In other implementations, the UE 115 may start the timer (or another timer) responsive to another event, such as after starting reconnection procedures or based on a time associated with a last failed transmission.

After beam failure and possible loss of connection/Uu link, the UE 115 may perform reconnection procedures, such as connection re-establishment procedures. As illustrated in the example of FIG. 9, at 935, the UE 115 performs beam failure operations with the base station 105. For example, the UE 115 may transmit a beam failure request and/or RACH request to the base station 105. To illustrate, the UE 115 may indicate to the base station 105 information regarding the beam failure as known in the art. Based on the beam failure information, the UE 115 and base station 105 may engage in RACH operations to recover from the beam failure. The RACH operations referred to herein may include a 2 or 4 step RACH process.

As a high level overview, the UE 115 may transmit a beam failure recovery request, such as in a schedule request, and transmit a beam failure recovery report to the base station 105. The beam failure report may indicate which beams failed, candidate beam or beams for future transmissions, or both to enable recovery from the beam failure.

In some such implementations, such as when the beam recovery operation times, out fails, or is otherwise not successfully (e.g., beam failure on other beams, candidate beams, etc. that persistent beam failure and/or radio link failure is established, the UE 115 and the base station 105 may perform RACH operations to recover from beam and/or radio link failure.

After 935, the UE 115 may recover from the beam failure or otherwise establish (e.g. re-establish) the Uu link with the base station 105 after performance of the beam failure recovery operations at 935. For example, the UE 115 may re-establish the Uu link with the base station 105 based on performing RACH procedures. To illustrate, the UE 115 and the base station 105 may exchange one or more higher layer (e.g., RRC) messages to restore the link or start a new link. The UE 115 may enter, transition to, or remain in a RRC CONNECTED mode with the base station 105 after performance of the beam failure recovery operations and upon establishing (e.g. re-establishing) the Uu link with the base station 105.

At 945, the base station 105 optionally transmits a RACH report request to the UE 115. For example, the base station 105 may receive a RACH indication from the UE 115 (not shown), and the base station 105 (e.g., the report manager 439 thereof) may generate a RACH report request based on and/or responsive to receiving a RACH report indication. The base station 105 may then send the RACH report indication to the UE 115 in a downlink transmission, such as a downlink control channel transmission. The RACH request may include an indication to send a RACH report or to send sidelink information in a RACH report (e.g., sidelink operations/activity information) or the sidelink operations/activity information. Additionally, or alternatively, the RACH report request may indicate the transmission resources in which the UE 115 is to transmit the RACH report (e.g., RACH report information), the sidelink operations/activity information, or both.

At 950, the UE 115 transmits RACH report information to the base station 105. For example, the UE 115 (e.g., the report manager 416 thereof) may transmit a Uu RACH report transmission to the base station 105 in an uplink transmission responsive to the RACH report request or upon reconnection to the base station 105 (e.g., some time after operations of the beam failure recovery operations at 935, and optionally RACH operations). To illustrate, the UE 115 (e.g., the report manager 416 thereof) may generate RACH report information based on the sidelink operations/activity information and include RACH report information (e.g., an enhanced RACH report) in a RACH report transmission, and the UE 115 may transmit the RACH report transmission to the base station 105 in an uplink transmission.

In some implementations, the UE 115 transmits the RACH report (or the sidelink information) to the base station 105 directly (e.g., pushes the sidelink information to network) without an indication or request, as illustrated in the example of FIG. 5. In other implementations, such as illustrated in the pull reporting scheme of FIG. 6, the network may pull the RACH report from the UE. For example and as described with reference to FIG. 6, the UE 115 may first transmit an indication (e.g., a scheduling request or other message) to the network indicating that the UE 115 has sidelink information or a RACH report to send. The UE 115 may then receive a request message from the base station 105 which schedules the transmission of the sidelink information and/or the RACH report.

Additionally, or alternatively, the UE 115 may transmit the sidelink information in a transmission which is separate from the RACH report. In such implementations, the UE 115 may transmit the sidelink information prior to or after the transmission of the RACH report at 945. The UE 115 may refrain from including or exclude the sidelink information from the RACH report.

When the sidelink information (e.g., sidelink related or operations information) is sent separately from a RACH report, the sidelink information (e.g., sidelink related or operations information) may be sent in another report in some implementations. As illustrative, non-limiting examples, the sidelink information indicating whether the sidelink was active and/or what resources were used may be sent in a connection establishment failure (CEF) report, a mobility history report (MHR), or a successful handover report (SHR). Examples of sending the sidelink information (e.g., sidelink related or operations information) in other reports are described further with reference to FIGS. 10 and 11.

After 945, the UE 115 may optionally re-establish the mode 1 resources for the PC5 link or configure new mode 1 resources based on information from the base station 105 in implementation where the UE 115 released mode 1 resources. The UE 115 and the second UE 903 may optionally engage in PC5 communications using mode 1 resources, mode 2 resources, or both.

Although not shown in the examples of FIG. 9, the second UE 903 may also experience a radio link failure with the base station 105 at any time during the operations of FIG. 9.

Although the example of FIG. 9 is described with reference to a beam failure for a Uu link, where the sidelink information includes sidelink operations information and the sidelink information is reported in a RACH report, in other implementations, the devices may report other types of sidelink information, report the sidelink information in other messages or reports, use other reporting schemes (e.g., push or pull), report the sidelink information in response to other types of failures and/or report the sidelink information in response to failures with the network, as described in the examples of FIGS. 5-8, 10, and 11. Accordingly, in the example, of FIG. 9, devices of the network may be able to engage in enhanced sidelink information reporting in a RACH report in response to a beam failure for a Uu link.

Referring to FIG. 10, FIG. 10 is a timing diagram 1000 illustrating a wireless communication system that supports enhanced sidelink information reporting according to one or more aspects. The example of FIG. 10 corresponds to an example of enhanced sidelink radio link failure information reporting for mobility history reporting operations. As compared to the example of FIG. 8 where a remote UE experiences a relay sidelink radio link failure, the example of FIG. 10 is directed to a remote UE that undergoes relay reselection (e.g., changes its relay link due to transition to idle mode, a handover operation, or a radio link failure) and that transmits sidelink related information (e.g., sidelink mobility and/or failure information) to the base station in a relayed mobility history report (MHR), such as a new sidelink or Relay history report or an enhanced mobility history report.

In prior Releases' a standard MHR only contains information of the visited cells (i.e., base stations) (either due to reselection or handover) and time spent per each visited cell. However, a remote UE which is connected to a relay UE via sidelink can undergo relay (re)selection in IDLE/INACTIVE state or perform handover procedures (indirect to direct and direct to indirect path switching). However, this information is currently not captured or reported.

The Relay MHR or enhanced MHR may include relay history information on connected/visited relay UEs, such as a last number (e.g., 1, 2, 4, 8, 16, 32, etc.) destination IDs involved in sidelink unicast for a given UE, time spent per each unicast link (i.e., per destination ID), time spent with dual connection, time spent with only Uu and no SL, time spent with only SL and no Uu, aggregated experience of users (e.g., if the sidelink was a groupcast or multicast), or a combination thereof.

The Relay MHR or enhanced MHR may include relay history information on connected/visited relay UEs, such as relay UE ID information, frequency of relay information, serving cell frequency information, serving cell ID information, time spent in each relay information, RRC state information, or a combination thereof. This visited relay UE information may enable performance of improved relay (re)selection or path switching in the future.

In some implementations, an out-of-coverage (OOC) definition may be modified or adjusted. For example, the network or UE may operate with a specific OOC definition or can change between two OOC definitions. As illustrative examples, OOC definitions may include a UE is considered OOC if there is no Uu coverage even if there is still PC5 coverage, or a UE is considered in coverage (i.e., not OOC) if there is no Uu coverage but there is still PC5 coverage. The OOC definition or condition may control or be used by the UE to determine whether to detect other alternate connections e.g., PC5 links.

The example of FIG. 10 includes similar devices to the devices described in FIGS. 1, 2, and 4, such as a UE 115 (e.g., a first UE or remote UE), a second UE 803a (e.g., a second 1003a or first relay UE), a third UE 1003b (e.g., a third UE 803b or second relay UE), and a network entity (e.g., base station 105). The devices of FIG. 10 may include one or more of the components as described in FIGS. 2 and 4. In FIG. 10, these devices may utilize antennas 252a-r, transmitter 410, receiver 412, encoder 413 and/or decoder 414, or may utilize antennas 234a-t, transmitter 434, receiver 436, encoder 437 and/or decoder 438 to communicate and receive transmissions. In some implementations, network entity may include or correspond to multiple TRPs of a single base station (e.g., base station 105), to multiple base stations, or any combination thereof.

At 1010, the base station 105 and the third UE 1003b establish a Uu communication link as described with reference to 510 of FIG. 5. At 1015, the base station 105 and the second UE 1003a establish a Uu communication link as described with reference to 510 of FIG. 5. At 1020, the UE 115 and the second UE 1003a establish a PC5 communication link (e.g., first PC5 communication link) as described with reference to 515 of FIG. 5. As described with reference to FIG. 5 at 520 and 525, the UE 115, the second UE 1003a, the third UE 1003b, and the base station 105 may communicate with each other over the communication links by transmitting and/or receiving transmissions. For example, the PC5 link between the UE 115 and the second UE 1003a may enable the UE 115 to connect or communicate with the base station 105, even if the UE 115 is considered a remote UE to the base station 105 and is located out of range of the base station 105 or outside of its coverage area. The PC5 link may enable relay communications, such as communications from the base station 105 or the UE 115 to be relayed to one another via the second UE 1003a. For example, a communication may be transmitted by sidelink from the UE 115 to the second UE 1003a and then relayed to the base station 105 via uplink.

At 1025, the UE 115 may perform a relay UE or relay cell reselection process. As illustrated in the example of FIG. 10, the UE 115 transitions to an idle or inactive mode or performs a handover operation from the second UE 1003a to the third UE 1003b to switch the PC5 link from the second UE 1003a to the third UE 1003b (e.g., end the link with the second UE 1003a and start a link with the third UE 1003b).

Additionally, or alternatively, the UE 115 may determine a sidelink radio link failure for a sidelink communication link. For example, the UE 115 may determine a sidelink radio link failure with the second UE 1003a as described with reference to 825 of FIG. 8. The sidelink radio link failure may cause the UE 115 to go into the INACTIVE/IDLE mode, occur during a handover operation, or cause performance of a reselection operation.

In connection with operation of the PC5 communication link and performance of relay reselection, the UE 115 may determine or generate sidelink link information, such as sidelink radio link failure information. For example, the UE 115 may determine or generate sidelink relay information during operation of the PC5 communication link, performance of relay reselection, transition to INACTIVE/IDLE mode, performance of a handover operation, and/or determination of the sidelink radio link failure.

To illustrate, the UE 115 may generate the sidelink relay information described above. As described with reference to FIG. 4, the sidelink link information (e.g., sidelink relay and/or failure information) may include enhanced information from information currently recorded in the art for SL operations and/or reported to other (e.g., network) devices for relay UE reselection. In the example, of FIG. 10, the sidelink radio link failure information may include Relay UE ID information, Frequency of relay link information, Serving cell frequency information, Serving cell ID information, relay duration information, RRC state information, sidelink resource activity information, or a combination thereof. After generation of the sidelink link information, such as sidelink radio relay information, the UE 115 may store such information in a current or new IE or variable, as described with reference to FIGS. 5-10.

At 1030, the UE 115 and the third UE 1003b establish a PC5 communication link, as described with reference to 830 of FIG. 8. For example, the UE 115 may perform RACH and/or connection establishment operations to establish (or re-establish) direct, device-to-device communication link with another UE that is connected to the network, such as base station 105 or another node of the network, such as a second base station. In some implementations, the communication link may be established as part of a handover operation or through another UE (e.g., from the second UE 1003a). As illustrated in the example of FIG. 10, the UE 115 and third UE 1003b may communicate higher layer signaling, such as RRC signaling (e.g., a RRC transmission or message) or control transmissions, to establish the connection. The UEs may have additional PC5 links with each other or with other devices (not shown).

After establishing the PC5 communication link, the UE 115 and the third UE 1003b may communicate or exchange transmissions. For example, the UE 115 may receive sidelink transmissions from the third UE 1003b and/or transmit sidelink transmissions to the third UE 1003b, such as to communicate data. The sidelink transmissions may be communicated in resources of one or more modes, such as mode 1 and/or mode 2. Mode 1 resources may include resources that are directly scheduled by the network and mode 2 resources may include resources that are allocated by the network and/or scheduled by the UEs themselves (e.g., the UE 115, the third UE 1003b, or both).

After performance of the cell reelection operations (e.g., from transition to IDLE/INACTIVE, from a handover, etc.) and establishment of the (second) PC5 link between the UE 115 and the third UE 1003b, the UE 115 transmits sidelink relay information to the base station 105 via the third UE 1003b.

As illustrated in the example of FIG. 10, the UE 115 transmits sidelink relay information to the third UE 1003b at 1035. For example, the UE 115 (e.g., the report manager 416 thereof) may transmit sidelink relay information to the third UE 1003b in a sidelink transmission. As another example, the UE 115 (e.g., the report manager 416 thereof) may transmit the sidelink relay information in a MHR transmission to the third UE 1003b in a sidelink transmission. To illustrate, the UE 115 (e.g., the report manager 416 thereof) may generate MHR information based on the sidelink relay information and include MHR information (e.g., an enhanced MHR report or relay MHR) in a MHR transmission, and the UE 115 may transmit the MHR transmission to the third UE 1003b in a sidelink transmission.

In some implementations, the UE 115 transmits the MHR transmission (or the sidelink relay information) to third UE 1003b directly (e.g., pushes the sidelink radio link failure information to the third UE 1003b) without an indication or request, similar to the examples of FIGS. 5 and 7. In other implementations, such as illustrated in the pull reporting scheme of FIG. 6, the third UE 1003b may pull the MHR from the UE 115. For example and as described with reference to FIG. 6, the UE 115 may first transmit an indication (e.g., a scheduling request or other message) to the third UE 1003b indicating that the UE 115 has an MHR or sidelink relay information to send. The UE 115 may then receive a request message from the third UE 1003b which schedules the transmission of the MHR and/or the sidelink relay information.

At 1040, the third UE 1003b transmits a MHR indication to the base station 105. For example, the report manager 416 of the third UE 1003b may generate a MHR indication based on the sidelink relay information or MHR information (e.g., relay MHR or an enhanced MHR), and the third UE 1003b may transmit the MHR indication to the base station 105 in an uplink transmission. The MHR indication may indicate that the third UE 1003b has a MHR (e.g., relay MHR) to send or sidelink information (e.g., sidelink relay information) to send, or a combination thereof.

At 1045, the base station 105 transmits a MHR request to the third UE 1003b. For example, the base station 105 may receive the MHR indication, and the base station 105 (e.g., the report manager 439 thereof) may generate a MHR request based on and/or responsive to receiving the MHR indication. The base station 105 may then send the MHR indication to the third UE 1003b in a downlink transmission, such as a downlink control channel transmission. The MHR request may include an indication to send a MHR, the sidelink radio link information, or both. Additionally, or alternatively, the MHR request may indicate the transmission resources in which the third UE 1003b is to transmit the MHR (e.g., MHR information), the sidelink relay information, or both.

At 1050, the third UE 1003b transmits MHR information to the base station 105. For example, the third UE 1003b may receive the MHR request and the third UE 1003b (e.g., the report manager 416 thereof) may transmit a MHR transmission to the base station 105 in an uplink transmission. To illustrate, the third UE 1003b (e.g., the report manager 416 thereof) may generate MHR information based on the sidelink relay information and include the MHR information (e.g., an enhanced SL RLF report) in a MHR transmission, and the third UE 1003b may transmit the MHR transmission to the base station 105 in an uplink transmission.

In other implementations, the third UE 1003b transmits the MHR (or the sidelink relay information) to the base station 105 directly (e.g., pushes the sidelink radio link failure information to network) without an indication or request, as illustrated in the examples of FIGS. 5 and 7.

At 1055, the UE 115 may optionally establish a PC5 link after transmission of the SL RLF report (and/or sidelink radio failure information). For example, the UE 115 may re-establish the PC5 link with the second UE 1003a as illustrated in FIG. 6. Alternatively, the UE 115 may establish a PC5 link (e.g., third PC5 link) with another UE (not shown) or not establish another PC5 link.

Although the example of FIG. 10 is described with reference to a sidelink link reselection for a remote UE, where the sidelink information includes sidelink mobility information and the sidelink information is reported in a mobility history report, in other implementations, the devices may report other types of sidelink information, report the sidelink information in other messages or reports, use other reporting schemes (e.g., push or pull), report the sidelink information in response to other types of failures and/or report the sidelink information in response to failures with the network, as described in the examples of FIGS. 5-9 and 11. Accordingly, in the example, of FIG. 10, devices of the network may be able to engage in enhanced sidelink information reporting in a mobility history report in response to a sidelink link reselection when the UE is a remote UE and out of coverage of the base station 105.

Referring to FIG. 11, FIG. 11 is a timing diagram 1100 illustrating a wireless communication system that supports enhanced sidelink information reporting according to one or more aspects. The example of FIG. 11 corresponds to an example of enhanced sidelink information reporting for connection establishment failure reporting operations. As compared to the examples of FIGS. 5-10, the example of FIG. 11 is directed to connection establishment failures (e.g., Uu or PC5) and transmission of relay related sidelink information (e.g., sidelink mobility and/or failure information) to the base station in a connection establishment failed (CEF) report, such as a new sidelink connection establishment failure report or an enhanced connection establishment failure report. In prior Releases' a connection establishment failed contained the cell identifiers (e.g., cell group identifier CGI) and measurements of failed and neighboring cells, and the CEF report was stored upon expiration of timer T300 or T319.

The example of FIG. 11 includes similar devices to the devices described in FIGS. 1, 2, and 4-10, such as a UE 115 (e.g., a first UE or remote UE), a second UE 1103 (e.g., second UE 403-1003b, etc. or relay UE), and a network entity (e.g., base station 105). The devices of FIG. 11 may include one or more of the components as described in FIGS. 2 and 4. In FIG. 11, these devices may utilize antennas 252a-r, transmitter 410, receiver 412, encoder 413 and/or decoder 414, or may utilize antennas 234a-t, transmitter 434, receiver 436, encoder 437 and/or decoder 438 to communicate and receive transmissions. In some implementations, network entity may include or correspond to multiple TRPs of a single base station (e.g., base station 105), to multiple base stations, or any combination thereof.

At 1110, the UE 115, the second UE 1103, and the base station 105 may perform connection establishment operations. For example, the UE 115, the second UE 1103, and the base station 105 may perform one or more operations of the connection establishment operations described in FIG. 3.

During or after completion of the connection establishment operations at 1110, the UE 115 and the second UE 1103 establish a PC5 communication link (e.g., PC5 communication link) as described with reference to 515 of FIG. 5. As described with reference to FIG. 5 at 525, the UE 115 and the second UE 1103 may communicate with each other over the PC5 communication link by transmitting and/or receiving transmissions. For example, the PC5 link between the UE 115 and the second UE 1103 may enable the UE 115 to connect or communicate with the base station 105, even if the UE 115 is considered a remote UE to the base station 105 and is located out of range of the base station 105 or outside of its coverage area. The PC5 link may enable relay communications, such as communications from the base station 105 or the UE 115 to be relayed to one another via the second UE 1103. For example, a communication may be transmitted by sidelink from the UE 115 to the second UE 1103 and then relayed to the base station 105 via uplink.

At 1115, the UE 115 determines a connection establishment failure for the connection establishment operations at 1110. For example, the UE 115 determines a connection establishment failure (e.g., Uu CE failure) with respect to establishing the Uu link (relay Uu link) with the base station 105 via the second UE 1103, or determines a connection establishment failure (e.g., PC5 CE failure) with respect to establishing the PC5 link with the second UE 1103. A CEF failure may be determined as known in the art. As illustrative examples, a PC5 CEF failure may occur due to poor relay selection, bad SL-RSRP measurements, expiration of a timer (e.g., T300-like timer expiry for sidelink), or a combination thereof.

At 1120, in implementations where the UE 115 determines a Uu CE failure and/or establishes a PC5 link, the UE 115 may optionally transmit and/or receive sidelink messages over the PC5 link to and/or from the second UE 1103, as described with reference to FIGS. 7 and 9.

At 1125, the UE 115, the second UE 1103, and the base station 105 may optionally perform connection establishment operations (e.g., second connection establishment operations or connection reestablishment operations). For example, the UE 115, the second UE 1103, and the base station 105 may perform one or more operations of the connection establishment operations of FIG. 3 to establish or re-establish the communication link which experienced the connection establishment failure.

After determining a CE failure and establishing a connection to the network, the UE 115 may transmit a CEF report with the sidelink information to the base station 105 via the second UE 1103 as illustrated in the example of FIG. 11. Alternatively, in other implementations where the CE failure was a PC5 CE failure, the UE 115 may transmit the CEF report with the sidelink information to the second UE 1103 and the second UE 1103 may not relay or transmit the sidelink information and/or CEF report to the base station 105.

As described with reference to FIG. 5, in connection with operation of the PC5 communication link and/or determination of CEF, the UE 115 may determine or generate sidelink link information, such as sidelink failure and/or relay information for CEF. For example, the UE 115 may determine sidelink relay and failure information (e.g., sidelink radio link failure information 408) based on the CE operations and/or sidelink communication link operations. As described with reference to FIG. 4, the sidelink link information (e.g., sidelink radio link failure information) may include enhanced information from information currently recorded in the art for SL operations and/or reported to other (e.g., network) devices for sidelink or Uu radio link failure.

As an illustrative, non-limiting example, when there is a PC5 CEF for the remote UE trying to establish a connection via relay, the sidelink information (e.g., sidelink relay and/or failure information) may include PC5 measurement information, relay ID information, connection failure count information, or a combination thereof. The PC5 measurement information may include PC5 measurements (e.g., SD-RSRP or SL-RSRP) for the failed L2 relay, PC5 measurements of other candidate relay UEs, or both, and the relay ID information may include the relay ID of the remote UE, the failed L2 relay ID of the relay UE, the relay IDs of the other candidate relay UEs. The relay IDs may include or correspond to UE IDs in some implementations. The connection failure count information may indicate or include a count or number of connection failures for a particular relay, a count for each relay, or a total count for all relays

As another illustrative, non-limiting example, when a PC5 connection is successful but there is a Uu CEF for a remote UE trying to establish a connection via relay, the sidelink information may include a relay indication. The relay indication or information indications that the CEF happened for a relay UE. Additionally, or alternatively, the sidelink information may include UE ID information, such as remote UE ID information, relay UE ID information, or both.

At 1130, the second UE 1103 optionally transmits a CEF report request to the UE 115. For example, the second UE 1103 may receive a CEF indication or otherwise determine the CEF failure and may generate a CEF report request based on and/or responsive to obtaining a CEF report indication or determining a CEF. The CEF report request may include an indication to send a CEF report (e.g., CEF report information), the sidelink information, or both. Additionally, or alternatively, the CEF report request may indicate the transmission resources in which the UE 115 is to transmit the CEF report (e.g., CEF report information), the sidelink information, or both.

At 1135, the UE 115 transmits a CEF report with the sidelink information to the second UE 1103. For example, the UE 115 may receive the CEF report request and the UE 115 (e.g., the report manager 416 thereof) may transmit a CEF report transmission to the second UE 1103 in a sidelink transmission. To illustrate, the UE 115 (e.g., the report manager 416 thereof) may generate CEF report information based on the sidelink information and include the CEF report information (e.g., an enhanced CEF report) in a CEF report transmission, and the UE 115 may transmit the CEF report transmission to the second UE 1103 in a sidelink transmission.

In other implementations, the UE 115 transmits the CEF report (or the sidelink information) to the second UE 1103 directly (e.g., pushes the sidelink radio link failure information to network) without an indication or request, as illustrated in the example of FIG. 5.

Additionally, or alternatively, the UE 115 may transmit the sidelink information in a transmission which is separate from the CEF report. In such implementations, the UE 115 may transmit the sidelink information prior to or after the transmission of the CEF report at 1135. The UE 115 may refrain from including or exclude the sidelink information from the CEF report.

At 1140, the second UE 1103 transmits a CEF report with the sidelink information to the base station 105. For example, the second UE 1103 may receive the sidelink information, such as in a CEF report, from the UE 115, and the second UE 1103 (e.g., the report manager 416 thereof) may transmit (e.g., relay) a CEF report transmission with the received sidelink information to the base station 105 in an uplink transmission based on the CEF. To illustrate, the second UE 1103 (e.g., the report manager 416 thereof) may generate CEF report information based on the sidelink information and include the CEF report information (e.g., an enhanced CEF report) in a CEF report transmission, and the second UE 1103 may transmit the CEF report transmission to the base station 105 in an uplink transmission.

In other implementations, the second UE 1103 transmits the CEF report (or the sidelink information) to the base station 105 directly (e.g., pushes the sidelink radio link failure information to network) without an indication or request, as illustrated in the examples of FIGS. 5 and 7. Alternatively, the network may pull the CEF as illustrated in the examples of FIGS. 6 and 8.

Additionally, or alternatively, the second UE 1103 may transmit the sidelink information in a transmission which is separate from the CEF report. In such implementations, the second UE 1103 may transmit the sidelink information prior to or after the transmission of the CEF report at 1140. The second UE 1103 may refrain from including or exclude the sidelink information from the CEF report.

In some implementations, RACH information is excluded or withheld from the CEF report to the second UE 1103, from the CEF report to base station or both. Currently, RACH information may be optionally included in a CEF report. When connection establishment operations involve a remote UE or relay UE, RACH information may be excluded from the CEF report (as RACH operations may not be performed). To illustrate, the network and devices may be configured to exclude RACH information from CEF reports when a condition or conditions are satisfied, such as by adjusting the RACH information IE of the CEF report to be conditional.

Although the example of FIG. 11 is described with reference described with reference to CEF for a remote UE, where the sidelink information includes relay related sidelink information and the sidelink information is reported in a CEF report, in other implementations, the devices may report other types of sidelink information, report the sidelink information in other messages or reports, use other reporting schemes (e.g., push or pull), report the sidelink information in response to other types of failures and/or report the sidelink information in response to failures with the network, as described in the examples of FIGS. 5-10. Accordingly, in the example, of FIG. 11, devices of the network may be able to engage in enhanced sidelink information reporting in a CEF report in response to a CEF when the UE is a remote UE and out of coverage of the base station 105.

Although not shown in the examples of FIGS. 8-11, the second UE and/or third UE may also experience a radio link failure with each other or with the base station 105 at any time during the operations of FIGS. 8-11.

Additionally, or alternatively, one or more operations of FIGS. 3-11 may be added, removed, substituted in other implementations. For example, in some implementations, a UE may determine sidelink RLF information and sidelink activity or mobility history information and may report one or more of the sidelink types of information in any of the reports described with reference to FIGS. 3-11.

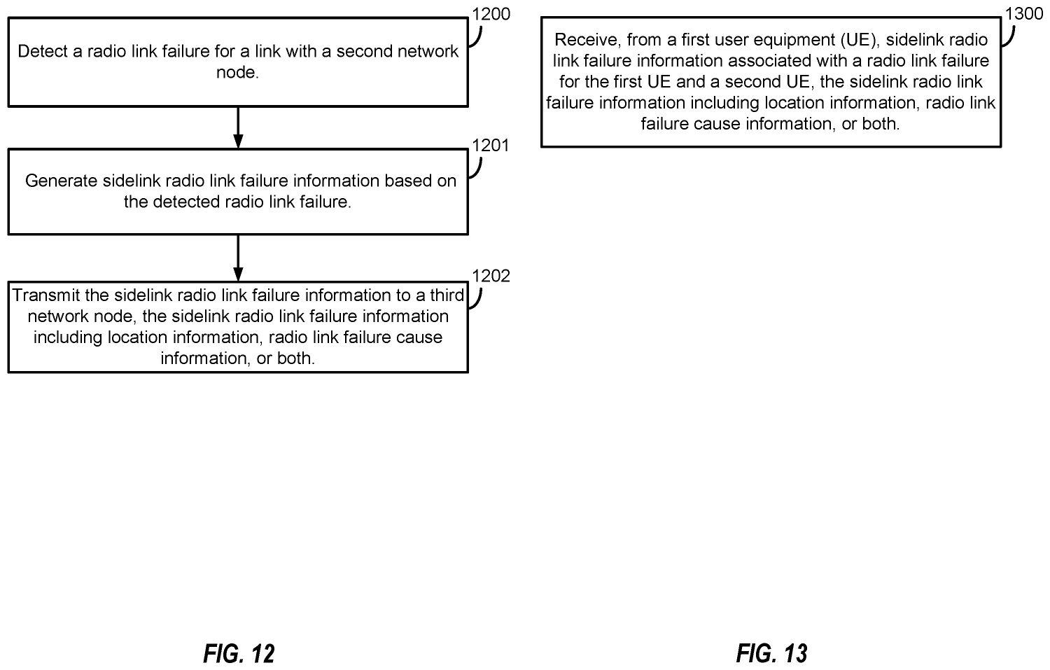

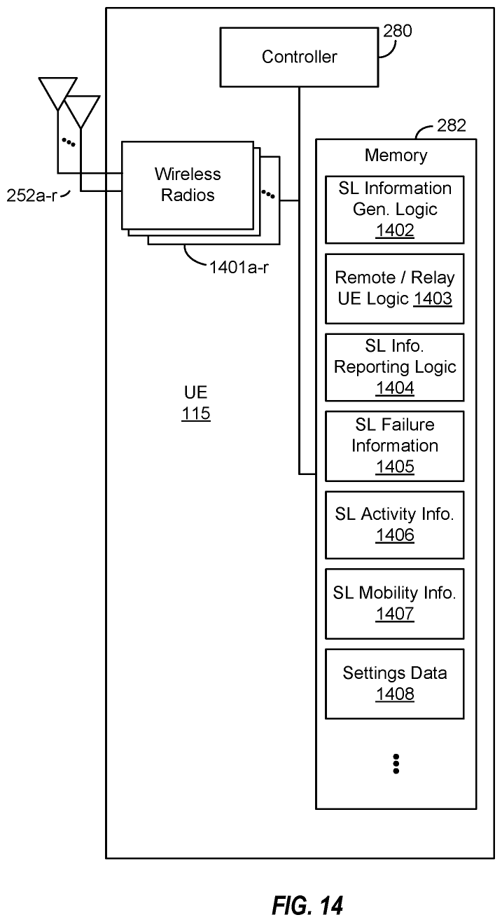

FIG. 12 is a flow diagram illustrating example blocks executed by a UE configured according to an aspect of the present disclosure. The example blocks will also be described with respect to UE 115 as illustrated in FIG. 14. FIG. 14 is a block diagram illustrating UE 115 configured according to one aspect of the present disclosure. UE 115 includes the structure, hardware, and components as illustrated for UE 115 of FIG. 2. For example, UE 115 includes controller/processor 280, which operates to execute logic or computer instructions stored in memory 282, as well as controlling the components of UE 115 that provide the features and functionality of UE 115. UE 115, under control of controller/processor 280, transmits and receives signals via wireless radios 1400a-r and antennas 252a-r. Wireless radios 1400a-r includes various components and hardware, as illustrated in FIG. 2 for UE 115, including modulator/demodulators 254a-r, MIMO detector 256, receive processor 258, transmit processor 264, and TX MIMO processor 266. As illustrated in the example of FIG. 14, memory 282 stores SL information generation logic 1402, relay/remote UE logic 1403, SL information reporting logic 1404, SL failure information data 1405, SL activity information 1406, SL mobility information 1407, and settings data 1408.

At block 1200, a wireless communication device, such as a UE, detects a radio link failure for a link with a second network node. For example, the UE 115 detects a sidelink RLF, as described with reference to FIGS. 4, 5, 6, and 8. To illustrate, an in coverage UE may determine a SL RLF for another UE or a remote UE may determine a SL RLF for its relay UE.

At block 1201, the UE 115 generates sidelink radio link failure information based on the detected radio link failure. For example, the UE 115 determines sidelink failure information 408 as described with reference to FIGS. 4, 5, 6, and 8.

At block 1202, the UE 115 transmits the sidelink radio link failure information to a third network node, the sidelink radio link failure information including location information, radio link failure cause information, or both. For example, the UE 115 transmits the report transmission 454 including the report information 442, which includes or was generated based on the sidelink failure information 408 and/or sidelink information 406, as described with reference to FIGS. 4, 5, 6, and 8. The location information may include or correspond to location information of the first UE, the second UE or both, and may be generated based on position and/or sensor information as described with reference to FIG. 4. The radio link failure cause information may include or correspond to an indication of a type of SL RLF or a cause of the SL RLF, as described with reference to FIG. 4.

The UE 115 may execute additional blocks (or the UE 115 may be configured further perform additional operations) in other implementations. For example, the UE 115 may perform one or more operations described above. As another example, the UE 115 may perform one or more aspects as described below.

In a first aspect, the radio link failure comprises a Uu interface radio link failure (RLF) or a sidelink RLF.

In a second aspect, alone or in combination with one or more of the above aspects, the radio link failure comprises a Uu interface RLF, and wherein the sidelink radio link failure information further includes an indication that the sidelink link was active during the Uu interface RLF, an indication that Mode-2 exception pool resources were used for the sidelink link, or both. Additionally or alternatively, the sidelink radio link failure information includes an indication of which Mode-2 exception pool resources were used.

In a third aspect, alone or in combination with one or more of the above aspects, the radio link failure comprises a sidelink RLF, and wherein the radio link failure cause information comprises sidelink radio link failure cause information and wherein the location information indicates a location of the first network node, the second network node, or both.

In a fourth aspect, alone or in combination with one or more of the above aspects, the location information indicates a location of the first network node and comprises UE position information, UE sensor information, or a combination thereof, and wherein the radio link failure cause information includes satisfaction of a timer condition (e.g., expiration of T400), satisfaction of a DTX condition, satisfaction of an RLC transmission count condition, satisfaction of an integrity check condition.

In a fifth aspect, alone or in combination with one or more of the above aspects, the as least one processor is configured to determine the location information based on UE position information, UE sensor information, or both.

In a sixth aspect, alone or in combination with one or more of the above aspects, the as least one processor is configured to determine the location information based on UE position information and UE sensor information includes to: determine UE position information based on satellite positioning information; and adjust the UE position information based on at least one of Bluetooth information, WLAN information, sensor information, or a combination thereof to generate the location information, wherein the sensor information include accelerometer information, barometer information, gyroscope information, inertial sensor information, or a combination thereof.

In a seventh aspect, alone or in combination with one or more of the above aspects, the sidelink radio link failure information is included in a radio link failure report (e.g., SidelinkUEInformationNR message).

In an eighth aspect, alone or in combination with one or more of the above aspects, the sidelink radio link failure information is transmitted separately from a radio link failure report (e.g., not in SidelinkUEInformationNR message or RLF report).

In a ninth aspect, alone or in combination with one or more of the above aspects, the sidelink radio link failure information is transmitted in a SL RLF report, wherein the SL RLF report includes a sidelink destination ID (or TX/RX UE ID), a time since Sidelink RLF, available measurement results, UE speed, UE direction, a RAT indication (e.g., LTE PC5 or NR PC5 RAT), an SL TX exception pool indication (e.g., if such were used during sidelink RLF and/or which exception pool resources were used), a connection reestablishment indication (e.g., Indication that CG-Type1 resources were released due to reestablishment), a zone ID, a TX-RX distance, a time stamp, sidelink frequency details (e.g., SL PointA, SL SSB frequency, SL SCS, valueN, Sync priority), or a combination thereof.

In a tenth aspect, alone or in combination with one or more of the above aspects, the at least one processor is configured to: transmit an indication which indicates a SL RLF report is available; receive a SL RLF report request indicating transmission resources for the SL RLF report; and transmit the SL RLF report including the sidelink radio link failure information in the transmission resources indicated by the SL RLF report request.

In an eleventh aspect, alone or in combination with one or more of the above aspects, the at least one processor is configured to: store the sidelink RLF information in a RLF report variable or a new SL RLF report variable.

In a twelfth aspect, alone or in combination with one or more of the above aspects, the radio link failure comprises a sidelink radio link failure (SL RLF), and wherein, prior to detecting the SL RLF, the at least one processor is configured to: establish a Uu link with the third network node; and establish a sidelink link with the second network node, wherein the Uu link and sidelink link are active prior to detecting the SL RLF.

In a thirteenth aspect, alone or in combination with one or more of the above aspects, the radio link failure comprises a sidelink radio link failure (SL RLF), and wherein the at least one processor is configured to: establish, prior to detecting the SL RLF, a Uu link with the third network node; establish, prior to detecting the SL RLF, a sidelink link with the second network node; receive, prior to detecting the SL RLF, a RRC message from the third network node; switch, prior to detecting the SL RLF, to an RRC IDLE or INACTIVE mode for the Uu link after receiving the RRC message, wherein the sidelink link is active prior to detecting the SL RLF; and resume the Uu link with the third network node after detecting the SL RLF and prior to transmitting the sidelink radio link failure information.

In a fourteenth aspect, alone or in combination with one or more of the above aspects, the radio link failure comprises a Uu RLF, and wherein the at least one processor is configured to: transmit sidelink activity information to the third network node, the sidelink activity information including an indication of whether a sidelink link with the second network was active after the detected Uu RLF failure.

In a fifteenth aspect, alone or in combination with one or more of the above aspects, the sidelink activity information further indicates which mode 2 exception pool resources were used after the detected Uu RLF failure.

In a sixteenth aspect, alone or in combination with one or more of the above aspects, the at least one processor is configured to: establish, prior to detecting the SL RLF, a sidelink link with the second network node (e.g., first relay UE), wherein the second network node has a Uu link with a fourth network node (e.g., base station); and establish, after detecting the SL RLF and prior to transmitting the sidelink radio link failure information, a second sidelink link with the third network node, wherein the fourth network node receives the sidelink radio link failure information from the third network node (e.g., second relay UE), and wherein the first network node does not have a direct Uu link with the fourth network node.

In a seventeenth aspect, alone or in combination with one or more of the above aspects, the sidelink radio link failure information further includes, original relay ID information, new relay ID information, relation reselection cause information, or a combination thereof.

In an eighteenth aspect, alone or in combination with one or more of the above aspects, the sidelink radio link failure further includes: UE ID information (e.g., serving cell ID/TAC) for failed relay UEs, attempted relay UEs, reestablished relay UEs, reconnected relay UEs, or a combination thereof, timing information for the connection failure; duration information for time since failure, time until reconnection, or both; connection failure type information; indication information for available serving relay and candidate relay sidelink measurement information; or a combination thereof.

In a nineteenth aspect, alone or in combination with one or more of the above aspects, the at least one processor is configured to: detect a beam failure for a beam associated with the second network node; perform beam failure recovery operations for the detected beam failure; generate sidelink activity information based on the detected beam failure, the sidelink activity information including an indication of whether the sidelink link was active during the beam failure recovery operations, an indication of what sidelink resources were used during the beam failure recovery operations, or both; and transmit the sidelink activity information to the third network node in a RACH report.

In a twentieth aspect, alone or in combination with one or more of the above aspects, the at least one processor is configured to: generate sidelink mobility history information; and transmit the sidelink mobility history information to the third network node (e.g., base station), wherein the sidelink mobility history information includes: destination ID information for sidelink unicast transmissions (e.g., a Last 32 Destination IDs involved in sidelink unicast for a given UE); sidelink unicast link duration information (e.g., time spent per each unicast link or per destination ID); dual connection duration information; Uu link only duration information; SL link only duration information; sidelink multicast information (e.g., if a sidelink TX was a groupcast or multicast, indicate the aggregated experience of the intended recipients); or a combination thereof.

In a twenty-first aspect, alone or in combination with one or more of the above aspects, the sidelink mobility history information is included in a MHR (e.g., enhanced MHR) or a sidelink MHR (new sidelink MHR), and wherein a UE is considered out of coverage (OOC) when there is no Uu coverage but there is still sidelink coverage or a UE is considered in coverage when there is no Uu coverage but there is still sidelink coverage.

In a twenty-second aspect, alone or in combination with one or more of the above aspects, the MHR or sidelink MHR further includes: Relay UE ID information; Frequency of relay information; Serving cell frequency information; Serving cell ID information; Time Spent in each relay information; RRC state information; or a combination thereof.

In a twenty-third aspect, alone or in combination with one or more of the above aspects, the at least one processor is configured to: perform connection establishment operations;
determine a connection establishment failure; and transmit a CEF report responsive to determining the connection establishment failure, the CEF report including UE relay related information.

In a twenty-fourth aspect, alone or in combination with one or more of the above aspects, determining the connection establishment failure includes determining the connection establishment failure based on a sidelink CEF, and wherein the CEF report includes: sidelink measurement information and UE ID information for failed relay UEs (e.g., SD-RSRP or SL-RSRP for L2 relay); sidelink measurement information and UE ID information of candidate relay UEs; per relay connection failure count information; or a combination thereof.

In a twenty-fifth aspect, alone or in combination with one or more of the above aspects, determining the connection establishment failure includes determining the connection establishment failure based on a Uu CEF, wherein the first network node successfully establishes a sidelink connection, and wherein the CEF report includes: relay UE CEF indication information (e.g., that the CEF happened for a relay UE); ID information for remote UE, relay ID or both; or a combination thereof.

In a twenty-sixth aspect, alone or in combination with one or more of the above aspects, determining the connection establishment failure includes determining the connection establishment failure based on a Uu CEF, wherein the first network node successfully establishes a sidelink connection, and wherein the at least one processor is configured to: refrain from including RACH information in the Uu CEF report when the connection establishment is performed via a relay UE.

In a twenty-seventh aspect, alone or in combination with one or more of the above aspects, the second network node comprises a UE and the third network node comprises a base station.

In a twenty-eighth aspect, alone or in combination with one or more of the above aspects, the sidelink radio link failure information is transmitted in a radio link failure (RLF) report, a Random Access Channel (RACH) report, a connection establishment failure (CEF) report, a mobility history report (MHR), or a successful handover report (SHR).

In a twenty-ninth aspect, alone or in combination with one or more of the above aspects, the as least one processor is configured to: receive a message from the third network node responsive to transmission of the sidelink radio link failure information; and performing recovery operations based on the receipt of the message.

In an additional aspect, a first network node for wireless communication includes: at least one processor; and a memory coupled to the at least one processor. The at least one processor is configured to: detect a failure for a link with a second network node; generate sidelink activity information based on sidelink activity with a third network node occurring after the detected failure; and transmit the sidelink activity information to the second network node, the sidelink activity information including an indication of whether a sidelink link with the third network was active after the detected failure.

In another aspect, alone or in combination with one or more of the above aspects, the failure comprises a Uu interface radio link failure (RLF) or a Uu interface beam failure.

In another aspect, alone or in combination with one or more of the above aspects, the indication comprises an indication that the sidelink link was active during the Uu interface RLF, wherein sidelink activity information further include an indication of what sidelink resources were used during RLF recovery operations, and wherein the sidelink activity information is transmitted to the second network node in a RLF report.

In another aspect, alone or in combination with one or more of the above aspects, the radio link failure comprises a Uu RLF, and the at least one processor is configured to: establish, prior to detecting the Uu RLF, a Uu link with the third network node; establish, prior to detecting the Uu RLF, a sidelink link with the second network node, wherein the Uu link and sidelink link are active prior to detecting the Uu RLF; start, after detecting the Uu RLF, a RLF timer (e.g., timer T311); release, after detecting the Uu RLF, mode 1 resources of the sidelink link; transmit a link reestablishment request the third network node; and reestablish the Uu link with the third network node based on the RRC reestablishment request prior to transmitting the sidelink activity information.

In another aspect, alone or in combination with one or more of the above aspects, the at least one processor is configured to: determine to use mode 2 exceptional pool resources for the sidelink link with the second network node based on a system information message (e.g., SIB) associated with the third network node; and transmit or receive sidelink data, using the mode 2 exceptional pool resources, with the second network node after detecting the Uu RLF and prior to transmitting the sidelink radio link failure information.

In another aspect, alone or in combination with one or more of the above aspects, the indication comprises an indication that the sidelink link was active during beam failure recovery operations for the detected Uu interface beam failure, wherein sidelink activity information further include an indication of what sidelink resources were used during the beam failure recovery operations, and wherein the sidelink activity information is transmitted to the second network node in a RACH report.

In an additional aspect, a first network node for wireless communication includes: at least one processor; and a memory coupled to the at least one processor. The at least one processor is configured to: detect an access or mobility event for a link with a second network node; generate sidelink access and mobility related information based on the detected access or mobility event; and transmit the sidelink access and mobility related information to a third network node in a mobility history report, the sidelink access and mobility related information including UE relay related information.

In another aspect, alone or in combination with one or more of the above aspects, the sidelink access and mobility related information includes: destination ID information for sidelink unicast transmissions; sidelink unicast link duration information; dual connection duration information; Uu link only duration information; SL link only duration information; sidelink multicast information; or a combination thereof.

In another aspect, alone or in combination with one or more of the above aspects, the sidelink access and mobility related information includes: relay UE ID information; frequency of relay information; serving cell frequency information; serving cell ID information; time spent in each relay information; RRC state information; or a combination thereof.

In an additional aspect, a first network node for wireless communication includes: at least one processor; and a memory coupled to the at least one processor. The at least one processor is configured to: detect an access or mobility event for a link with a second network node; generate sidelink access and mobility related information based on the detected access or mobility event; and transmit the access and mobility related information to a third network node in a connection establishment failure report, the access and mobility related information including UE relay related information.

In another aspect, alone or in combination with one or more of the above aspects, to determine the connection establishment failure includes to determine the connection establishment failure based on a sidelink CEF, and the CEF report includes (e.g., the access and mobility related information includes or corresponds to): sidelink measurement information and UE ID information for failed relay UEs; sidelink measurement information and UE ID information of candidate relay UEs; per relay connection failure count information; or a combination thereof.

In another aspect, alone or in combination with one or more of the above aspects, to determine the connection establishment failure includes to determine the connection establishment failure based on a Uu CEF, where the first network node successfully establishes a sidelink connection, and the CEF report includes: relay UE CEF indication information; ID information for remote UE, relay ID or both; or a combination thereof.

In another aspect, alone or in combination with one or more of the above aspects, to determine the connection establishment failure includes to determine the connection establishment failure based on a Uu CEF, wherein the first network node successfully establishes a sidelink connection, and wherein the at least one processor is configured to: refrain from including RACH information in the Uu CEF report when the connection establishment is performed via a relay UE.

Accordingly, a UE and a base station may perform enhanced sidelink information reporting operations. By performing enhanced sidelink information reporting operations, throughput and reliability may be increased due to reduced failures and improved operations and/or additional capabilities when operating in sidelink and/or when out of coverage of a network device.

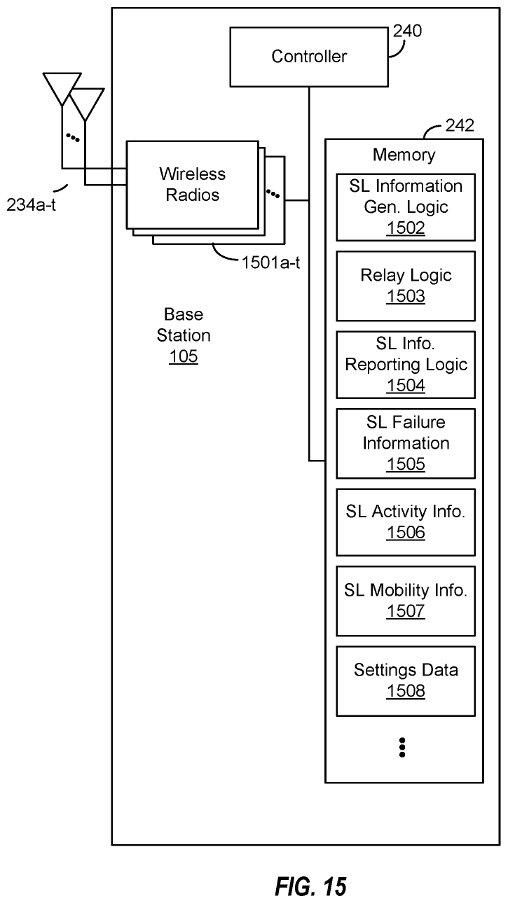

FIG. 13 is a flow diagram illustrating example blocks executed by wireless communication device configured according to another aspect of the present disclosure. The example blocks will also be described with respect to base station 105 (e.g., gNB) as illustrated in FIG. 15. FIG. 15 is a block diagram illustrating base station 105 configured according to one aspect of the present disclosure. Base station 105 includes the structure, hardware, and components as illustrated for base station 105 of FIG. 2. For example, base station 105 includes controller/processor 240, which operates to execute logic or computer instructions stored in memory 242, as well as controlling the components of base station 105 that provide the features and functionality of base station 105. Base station 105, under control of controller/processor 240, transmits and receives signals via wireless radios 1501a-t and antennas 234a-t. Wireless radios 1501a-t includes various components and hardware, as illustrated in FIG. 2 for base station 105, including modulator/demodulators 232a-t, MIMO detector 236, receive processor 238, transmit processor 220, and TX MIMO processor 230. As illustrated in the example of FIG. 15, memory 242 stores SL information generation logic 1502, relay/remote UE logic 1503, SL information reporting logic 1504, SL failure information data 1505, SL activity information 1506, SL mobility information 1507, and settings data 1508. One of more of 1502-1508 may include or correspond to one of 1402-1408.

At block 1300, a wireless communication device, such as a base station, receives, from a first user equipment (UE), sidelink radio link failure information associated with a radio link failure for the first UE and a second UE, the sidelink radio link failure information including location information, radio link failure cause information, or both. For example, the base station 105 receives the report transmission 454 including the report information 442, which includes or indicates based on the sidelink failure information 408, as described with reference to FIGS. 4, 5, 6, and 8. The first UE may include or correspond to an in coverage UE or a relay UE. The second UE may include or correspond to a second UE or remote UE (e.g., out of coverage UE without a direct Uu link). The SL RLF may be detected by the first UE, the second UE, or both. The location information may include or correspond to location information of the first UE, the second UE or both, and may be generated based on position and/or sensor information as described with reference to FIG. 4. The radio link failure cause information may include or correspond to an indication of a type of SL RLF or a cause of the SL RLF, as described with reference to FIG. 4.

The base station 105 may execute additional blocks (or the base station 105 may be configured further perform additional operations) in other implementations. For example, the base station 105 may perform one or more operations described above. As another example, the base station 105 may perform one or more aspects as described below.

In a first aspect, the radio link failure comprises a Uu interface radio link failure (RLF) or a sidelink RLF.

In a second aspect, alone or in combination with one or more of the above aspects, the radio link failure comprises a Uu interface RLF, and wherein the sidelink radio link failure information further includes an indication that the sidelink link was active during the Uu interface RLF, an indication that Mode-2 exception pool resources were used for the sidelink link, or both.

In a third aspect, alone or in combination with one or more of the above aspects, the radio link failure comprises a sidelink RLF, and wherein the radio link failure cause information comprises sidelink radio link failure cause information and wherein the location information indicates a location of the first network node, the second network node, or both.

In a fourth aspect, alone or in combination with one or more of the above aspects, the location information indicates a location of the first network node and comprises UE position information, UE sensor information, or a combination thereof, and wherein the radio link failure cause information includes satisfaction of a timer condition (e.g., expiration of T400), satisfaction of a DTX condition, satisfaction of an RLC transmission count condition, satisfaction of an integrity check condition.

In a fifth aspect, alone or in combination with one or more of the above aspects, the sidelink radio link failure information is included in a radio link failure report (e.g., SidelinkUEInformationNR message).

In a sixth aspect, alone or in combination with one or more of the above aspects, the sidelink radio link failure information is included in a radio link failure report (e.g., SidelinkUEInformationNR message).

In a seventh aspect, alone or in combination with one or more of the above aspects, the sidelink radio link failure information is transmitted separately from a radio link failure report (e.g., not in SidelinkUEInformationNR message or RLF report).

In an eighth aspect, alone or in combination with one or more of the above aspects, the sidelink radio link failure information is transmitted in a SL RLF report, wherein the SL RLF report includes a sidelink destination ID (or TX/RX UE ID), a time since Sidelink RLF, available measurement results, UE speed, UE direction, a RAT indication (e.g., LTE PC5 or NR PC5 RAT), an SL TX exception pool indication, a connection reestablishment indication (e.g., Indication where CG-Type1 resources were released due to reestablishment), a zone ID, a TX-RX distance, a time stamp, sidelink frequency details (e.g., (SL PointA, SL SSB frequency, SL SCS, valueN, Sync priority)), or a combination thereof.

In a ninth aspect, alone or in combination with one or more of the above aspects, the at least one processor is configured to: receive an indication which indicates a SL RLF report is available; transmit a SL RLF report request indicating transmission resources for the SL RLF report; and receive the SL RLF report including the sidelink radio link failure information in the transmission resources indicated by the SL RLF report request.

In a tenth aspect, alone or in combination with one or more of the above aspects, the radio link failure comprises a sidelink radio link failure (SL RLF).

In an eleventh aspect, alone or in combination with one or more of the above aspects, the radio link failure comprises a sidelink radio link failure (SL RLF), and wherein the at least one processor is configured to: resume the Uu link with the third network node after detecting the SL RLF and prior to transmitting the sidelink radio link failure information.

In a twelfth aspect, alone or in combination with one or more of the above aspects, the radio link failure comprises a Uu RLF, and wherein the at least one processor is configured to: receive sidelink activity information, the sidelink activity information including an indication of whether a sidelink link with the second network was active after the detected Uu RLF failure.

In a thirteenth aspect, alone or in combination with one or more of the above aspects, the sidelink radio link failure information further includes, original relay ID information, new relay ID information, relation reselection cause information, or a combination thereof.

In a fourteenth aspect, alone or in combination with one or more of the above aspects, the sidelink activity information further indicates which mode 2 exception pool resources were used after the detected Uu RLF failure.

In a fifteenth aspect, alone or in combination with one or more of the above aspects, the sidelink radio link failure further includes: UE ID information (e.g., serving cell ID/TAC) for failed relay UEs, attempted relay UEs, reestablished relay UEs, reconnected relay UEs, or a combination thereof, timing information for the connection failure; duration information for time since failure, time until reconnection, or both; connection failure type information; indication information for available serving relay and candidate relay sidelink measurement information; or a combination thereof.

In a sixteenth aspect, alone or in combination with one or more of the above aspects, the sidelink mobility history information is included in a MHR (e.g., enhanced MHR) or a sidelink MHR (new sidelink MHR), and wherein a UE is considered out of coverage (OOC) when there is no Uu coverage but there is still sidelink coverage or a UE is considered in coverage when there is no Uu coverage but there is still sidelink coverage.

In a seventeenth aspect, alone or in combination with one or more of the above aspects, the MHR or sidelink MHR further includes: Relay UE ID information; Frequency of relay information; Serving cell frequency information; Serving cell ID information; Time Spent in each relay information; RRC state information; or a combination thereof.

In an eighteenth aspect, alone or in combination with one or more of the above aspects, the at least one processor is configured to: perform connection establishment operations determine a connection establishment failure; and transmit a CEF report responsive to determining the connection establishment failure, the CEF report including UE relay related information.

In a nineteenth aspect, alone or in combination with one or more of the above aspects, determining the connection establishment failure includes determining the connection establishment failure based on a sidelink CEF, and wherein the CEF report includes: sidelink measurement information and UE ID information for failed relay UEs; sidelink measurement information and UE ID information of candidate relay UEs; per relay connection failure count information; or a combination thereof.

In a twentieth aspect, alone or in combination with one or more of the above aspects, determining the connection establishment failure includes determining the connection establishment failure based on a Uu CEF, wherein the first network node successfully establishes a sidelink connection, and wherein the CEF report includes: relay UE CEF indication information (e.g., that this CEF happened for a relay UE); ID information for remote UE, relay ID or both; or a combination thereof.

In a twenty-first aspect, alone or in combination with one or more of the above aspects, determining the connection establishment failure includes determining the connection establishment failure based on a Uu CEF, wherein the first network node successfully establishes a sidelink connection, and wherein the at least one processor is configured to: refrain from including RACH information in the Uu CEF report when the connection establishment is performed via a relay UE.

In a twenty-second aspect, alone or in combination with one or more of the above aspects, the sidelink radio link failure information is transmitted in a radio link failure (RLF) report, a Random Access Channel (RACH) report, a connection establishment failure (CEF) report, a mobility history report (MHR), or a successful handover report (SHR).

In a twenty-third aspect, alone or in combination with one or more of the above aspects, the as least one processor is configured to: transmit a message responsive to transmission of the sidelink radio link failure information; and perform recovery operations based on the receipt of the message.

In an additional aspect, a first network node for wireless communication includes: at least one processor; and a memory coupled to the at least one processor. The at least one processor is configured to: determine a failure for a link with a first user equipment (UE); and receive, from the first UE, sidelink activity information associated the first UE and a second UE, the sidelink activity information including an indication of whether a sidelink link between the first UE and the second UE was active after the determined failure.

In an additional aspect, a first network node for wireless communication includes: at least one processor; and a memory coupled to the at least one processor. The at least one processor is configured to: receive, from a first user equipment (UE), sidelink access and mobility related information associated with an access or mobility event for the first UE and a second UE in a mobility history report, the sidelink radio link failure information including UE relay related information.

In an additional aspect, a first network node for wireless communication includes: at least one processor; and a memory coupled to the at least one processor. The at least one processor is configured to: determine a connection establishment failure for a link with a user equipment (UE); and receive, from the UE, sidelink access and mobility related information in a connection establishment failure report, the sidelink radio link failure information including UE relay related information.

Accordingly, a UE and a base station may perform enhanced sidelink information reporting operations. By performing enhanced sidelink information reporting operations, throughput and reliability may be increased due to reduced failures and improved operations and/or additional capabilities when operating in sidelink and/or when out of coverage of a network device.

As described herein, a node (which may be referred to as a node, a network node, a network entity, or a wireless node) may include, be, or be included in (e.g., be a component of) a base station (e.g., any base station described herein), a UE (e.g., any UE described herein), a network controller, an apparatus, a device, a computing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein. For example, a network node may be a UE. As another example, a network node may be a base station or network entity. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE is configured to receive information from a base station also discloses that a first network node is configured to receive information from a second network node, the first network node may refer to a first UE, a first base station, a first apparatus, a first device, a first computing system, a first set of one or more one or more components, a first processing entity, or the like configured to receive the information; and the second network node may refer to a second UE, a second base station, a second apparatus, a second device, a second computing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Components, the functional blocks, and the modules described herein with respect to FIGS. 1-15 include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. In addition, features discussed herein may be implemented via specialized processor circuitry, via executable instructions, or combinations thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, that is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

As used herein, including in the claims, the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof. The term “substantially” is defined as largely but not necessarily wholly what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes 0.1, 1, 5, or 10 percent.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A first network node for wireless communication, comprising:
at least one processor; and
a memory coupled to the at least one processor,
wherein the at least one processor is configured to:
detect a radio link failure for a link with a second network node;
generate sidelink radio link failure information based on the detected radio link failure; and
transmit the sidelink radio link failure information to a third network node, the sidelink radio link failure information including location information, radio link failure cause information, or both.

2. The first network node of claim 1, wherein the radio link failure comprises a Uu interface radio link failure (RLF) or a sidelink RLF.

3. The first network node of claim 1, wherein the radio link failure comprises a Uu interface RLF, and wherein the sidelink radio link failure information further includes an indication that a sidelink link was active during the Uu interface RLF, an indication that Mode-2 exception pool resources were used for the sidelink link, or both.

4. The first network node of claim 1, wherein the radio link failure comprises a sidelink RLF, and wherein the radio link failure cause information comprises sidelink radio link failure cause information and wherein the location information indicates a location of the first network node, the second network node, or both.

5. The first network node of claim 1, wherein the location information indicates a location of the first network node and comprises UE position information, UE sensor information, or a combination thereof, and wherein the radio link failure cause information includes satisfaction of a timer condition, satisfaction of a DTX condition, satisfaction of an RLC transmission count condition, satisfaction of an integrity check condition.

6. The first network node of claim 1, wherein the as least one processor is configured to determine the location information based on UE position information, UE sensor information, or both.

7. The first network node of claim 4, wherein the as least one processor is configured to determine the location information based on UE position information and UE sensor information includes to:
determine UE position information based on satellite positioning information; and
adjust the UE position information based on at least one of Bluetooth information, WLAN information, sensor information, or a combination thereof to generate the location information, wherein the sensor information include accelerometer information, barometer information, gyroscope information, inertial sensor information, or a combination thereof.

8. The first network node of claim 1, wherein the sidelink radio link failure information is included in a radio link failure report.

9. The first network node of claim 1, wherein the sidelink radio link failure information is transmitted separately from a radio link failure report.

10. The first network node of claim 1, wherein the sidelink radio link failure information is transmitted in a SL RLF report, wherein the SL RLF report includes a sidelink destination ID, a time since Sidelink RLF, available measurement results, UE speed, UE direction, a RAT indication, an SL TX exception pool indication, a connection reestablishment indication, a zone ID, a TX-RX distance, a time stamp, sidelink frequency details, or a combination thereof.

11. The first network node of claim 1, wherein the at least one processor is configured to:
transmit an indication which indicates a SL RLF report is available;
receive a SL RLF report request indicating transmission resources for the SL RLF report; and
transmit the SL RLF report including the sidelink radio link failure information in the transmission resources indicated by the SL RLF report request.

12. The first network node of claim 1, wherein the radio link failure comprises a sidelink radio link failure (SL RLF), and wherein, prior to detecting the SL RLF, the at least one processor is configured to:
establish a Uu link with the third network node; and
establish a sidelink link with the second network node, wherein the Uu link and sidelink link are active prior to detecting the SL RLF.

13. The first network node of claim 1, wherein the radio link failure comprises a sidelink radio link failure (SL RLF), and wherein the at least one processor is configured to:
establish, prior to detecting the SL RLF, a Uu link with the third network node;
establish, prior to detecting the SL RLF, a sidelink link with the second network node;
receive, prior to detecting the SL RLF, a RRC message from the third network node;
switch, prior to detecting the SL RLF, to an RRC IDLE or INACTIVE mode for the Uu link after receiving the RRC message, wherein the sidelink link is active prior to detecting the SL RLF; and
resume the Uu link with the third network node after detecting the SL RLF and prior to transmitting the sidelink radio link failure information.

14. The first network node of claim 1, wherein the radio link failure comprises a Uu RLF, and wherein the at least one processor is configured to:
transmit sidelink activity information to the third network node, the sidelink activity information including an indication of whether a sidelink link with the second network was active after the Uu RLF.

15. The first network node of claim 14, wherein the sidelink activity information further indicates which mode 2 exception pool resources were used after the Uu RLF.

16. The first network node of claim 1, wherein the radio link failure comprises a sidelink radio link failure (SL RLF), and wherein the at least one processor is configured to:
establish, prior to detection of the SL RLF, a sidelink link with the second network node, wherein the second network node has a Uu link with a fourth network node; and
establish, after detection of the SL RLF and prior to transmission of the sidelink radio link failure information, a second sidelink link with the third network node, wherein the fourth network node receives the sidelink radio link failure information from the third network node, and wherein the first network node does not have a direct Uu link with the fourth network node.

17. The first network node of claim 16, wherein the sidelink radio link failure information further includes original relay ID information, new relay ID information, relation reselection cause information, or a combination thereof.

18. The first network node of claim 1, wherein the sidelink radio link failure further includes:
UE ID information for failed relay UEs, attempted relay UEs, reestablished relay UEs, reconnected relay UEs, or a combination thereof,
timing information for connection failures;
duration information for time since failure, time until reconnection, or both;
connection failure type information;
indication information for available serving relay and candidate relay sidelink measurement information; or
a combination thereof.

19. The first network node of claim 1, wherein the link is a sidelink link, and wherein the at least one processor is configured to:
detect a beam failure for a beam associated with the second network node;
perform beam failure recovery operations for the detected beam failure;
generate sidelink activity information based on the detected beam failure, the sidelink activity information including an indication of whether the sidelink link was active during the beam failure recovery operations, an indication of what sidelink resources were used during the beam failure recovery operations, or both; and
transmit the sidelink activity information to the third network node in a RACH report.

20. The first network node of claim 1, wherein the at least one processor is configured to:
generate sidelink mobility history information; and
transmit the sidelink mobility history information to the third network node, wherein the sidelink mobility history information includes:
destination ID information for sidelink unicast transmissions;
sidelink unicast link duration information;
dual connection duration information;
Uu link only duration information;
SL link only duration information;
sidelink multicast information; or
a combination thereof.

21. The first network node of claim 20, wherein the sidelink mobility history information is included in a MHR or a sidelink MHR, and wherein a UE is considered out of coverage (OOC) when there is no Uu coverage but there is still sidelink coverage or a UE is considered in coverage when there is no Uu coverage but there is still sidelink coverage.

22. The first network node of claim 21, wherein the MHR or sidelink MHR further includes:
relay UE ID information;
frequency of relay information;
serving cell frequency information;
serving cell ID information;
time Spent in each relay information;
RRC state information; or
a combination thereof.

23. The first network node of claim 1, wherein the at least one processor is configured to:
perform connection establishment operations;
determine a connection establishment failure; and
transmit a CEF report responsive to determining the connection establishment failure, the CEF report including UE relay related information.

24. The first network node of claim 23, wherein to determine the connection establishment failure includes to determine the connection establishment failure based on a sidelink CEF, and wherein the CEF report includes:
sidelink measurement information and UE ID information for failed relay UEs;
sidelink measurement information and UE ID information of candidate relay UEs;
per relay connection failure count information; or
a combination thereof.

25. The first network node of claim 23, wherein to determine the connection establishment failure includes to determine the connection establishment failure based on a Uu CEF, wherein the first network node successfully establishes a sidelink connection, and wherein the CEF report includes:
relay UE CEF indication information;
ID information for remote UE, relay ID or both; or
a combination thereof.

26. The first network node of claim 23, wherein to determine the connection establishment failure includes to determine the connection establishment failure based on a Uu CEF, wherein the first network node successfully establishes a sidelink connection, and wherein the at least one processor is configured to:
refrain from including RACH information in the Uu CEF report when the connection establishment is performed via a relay UE.

27. The first network node of claim 1, wherein the second network node comprises a UE and the third network node comprises a base station.

28. The first network node of claim 1, wherein the sidelink radio link failure information is transmitted in a radio link failure (RLF) report, a Random Access Channel (RACH) report, a connection establishment failure (CEF) report, a mobility history report (MHR), or a successful handover report (SHR).

29. The first network node of claim 1, wherein the as least one processor is configured to:
receive a message from the third network node responsive to transmission of the sidelink radio link failure information; and
perform recovery operations based on the receipt of the message.

30. A first network node for wireless communication, comprising:
at least one processor; and
a memory coupled to the at least one processor,
wherein the at least one processor is configured to:
receive, from a first user equipment (UE), sidelink radio link failure information associated with a radio link failure for the first UE and a second UE, the sidelink radio link failure information including location information, radio link failure cause information, or both.
